(19) United States
(12) Patent Application Publication
(10) Pub. No.: US 2016/0285834 A1
(43) Pub. Date: Sep. 29, 2016

(54) TECHNIQUES FOR ENCRYPTING FIELDS OF A FRAME HEADER FOR WI-FI PRIVACY

(71) Applicant: QUALCOMM Incorporated, San Diego, CA (US)

(72) Inventors: Soo Bum Lee, San Diego, CA (US); Jouni Kalevi Malinen, Tuusula (FI); George Cherian, San Diego, CA (US)

(21) Appl. No.: 14/928,569

(22) Filed: Oct. 30, 2015

Related U.S. Application Data
(60) Provisional application No. 62/077,805, filed on Nov. 10, 2014.

(51) Int. Cl. H04L 29/06; H04W 12/06; H04W 12/04; H04L 29/12; H04L 9/14

(52) U.S. Cl. CPC H04L 63/0428; H04L 69/22; H04L 61/6022; H04L 63/06; H04L 9/14; H04L 63/0876; H04W 12/04; H04W 12/06

(57) ABSTRACT

Methods, systems, apparatuses, and devices are described for wireless station privacy using encryption to protect destination and source addresses of data frames. In one example, a method includes identifying a source address, a destination address, or any combination thereof to be transmitted in a plain-text portion of a data frame. The method may also include extracting the identified source address, the identified destination address, or any combination thereof. The method also includes inserting the extracted source address, the extracted destination address, or any combination thereof in a frame body of the data frame. The method may further include encrypting the inserted source address, the inserted destination address, or any combination thereof in the frame body.

### CROSS REFERENCES

The present Application for Patent claims priority to U.S. Provisional Patent Application No. 62/077,805 by Lee et al., entitled “Techniques for Encrypting Fields of a Frame Header for Wi-Fi Privacy,” filed Nov. 10, 2014, assigned to the assignee hereof.

### BACKGROUND

1. Field of the Disclosure

The present disclosure, for example, relates to wireless communication systems, and more particularly to privacy in a wireless station using medium access control headers.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a Wireless Local Area Network (WLAN), such as a Wi-Fi network (IEEE 802.11) may include an access point (AP) that may communicate with at least one station (STA) or mobile device. The AP may be coupled to a network, such as the Internet, and enable a mobile device to communicate via the network (and/or communicate with other devices coupled to the access point).

Privacy issues relating to Wi-Fi networks are a concern for network providers and users alike. Typically, a data frame sent over-the-air between a STA or AP wirelessly communicating with another STA or AP includes a source address and a destination address in a medium access control (MAC) header of the data frame. A STA or AP sending such a data frame presents an opportunity to an observer to intercept the wireless transmissions, identify the destination or the source of the data frame, and determine information otherwise considered private and personal. For example, an observer or attacker can track the data frame, identify the user originating or receiving the data frame (e.g., personally identifying information), perform traffic analysis (e.g., determine the activities of the user sending the data frame), track the source of the data frame, and the like.

### SUMMARY

The described features generally relate to various improved systems, methods, or apparatuses for wireless communications. Such systems, methods, or apparatuses may provide for hiding source or destination addresses to improve privacy and prevent an observer from determining the source or destination of a data frame. The techniques may include methods for copying addresses from an address 3 field and an address 4 field of a plain-text portion and inserting them into an encrypted frame body. The plain-text copies of the addresses in the address 3 field and the address 4 field may be altered to protect the identities or deleted entirely. If a wireless station or access point receives an encrypted data frame, the techniques may include methods for extracting the values for the address 3 field and the address 4 field from the encrypted frame body.

In a first set of illustrative examples, a method for wireless communication is described. In one configuration, the method includes identifying a source address, a destination address, or any combination thereof to be transmitted in a plain-text portion of a data frame. The method also includes extracting the identified source address, the identified destination address, or any combination thereof. The method further includes inserting the extracted source address, the extracted destination address, or any combination thereof in a frame body of the data frame. The method also includes encrypting the inserted source address, the inserted destination address, or any combination thereof in the frame body.

In some cases, the identified source address, the identified destination address, or any combination thereof may be extracted from the plain-text portion of the data frame. In another example, extracting the identified source address, the identified destination address, or any combination thereof further includes modifying at least one address field of the plain-text portion of the data frame. In some examples, modifying the at least one address field further includes setting the at least one address field to a fixed value. In another example, modifying the at least one address field further includes removing the source address, the destination address, or any combination thereof from the plain-text portion of the data frame.

In some examples of the method, the plain-text portion of the data frame includes a medium access control (MAC) header.

In some examples, inserting the extracted source address, the extracted destination address, or any combination thereof further includes appending the source address, or the destination address, or any combination thereof to a beginning of the frame body. In some examples, appending the source address, or the destination address, or any combination thereof further includes appending the destination address to the beginning of the source address.

In some examples of the method, inserting the extracted source address, the extracted destination address, or any combination thereof further includes appending at least one of the source address, or the destination address, or any combination thereof to an end of the frame body.

In another example, the method includes indicating the encryption of the source address, the destination address, or any combination thereof in a security association with a receiver of the data frame. In some examples, the security association comprises a 4-way handshake procedure. In another example, the method includes signaling a syntax element to a receiver that indicates a presence of the source address, the destination address, or any combination thereof in the frame body.

The method may also include transmitting the data frame according to an address that is different from the source address and the destination address. In some examples, the method includes receiving the data frame, identifying the source address, the destination address, or any combination thereof from an encrypted frame body of the data frame, identifying an intermediary address based at least in part on the destination address, and transmitting the data frame according to the intermediary address.

In a second set of illustrative examples, an apparatus for wireless communication is described. In one configuration, the apparatus may include means for identifying a source address, a destination address, or any combination thereof to be transmitted in a plain-text portion of a data frame. The apparatus may also include means for extracting the identified source address, the identified destination address, or any combination thereof. The apparatus may further include means for inserting the extracted source address, the extracted destination address, or any combination thereof in a frame body of the data frame. The apparatus may also include means for encrypting the inserted source address, the inserted destination address, or any combination thereof in the frame body.

In a third set of illustrative examples, another apparatus for wireless communication is described. In one configuration, the apparatus may include a medium access control (MAC) address privacy component to identify a source address, a destination address, or any combination thereof to be transmitted in a plain-text portion of a data frame and to extract the identified source address, the identified destination address, or any combination thereof. The apparatus may also include a MAC address update component to insert the extracted source address, the extracted destination address, or any combination thereof in a frame body of the data frame. The apparatus may also include a frame body encryption component to encrypt the at least one of the inserted source address, or the inserted destination address, or any combination thereof in the frame body. The MAC address privacy component may be further to modify at least one address filed of the plain-text portion of the data frame.

In a fourth set of illustrative examples, a computer program product for communication by a wireless communication apparatus in a wireless communication system is described. In one configuration, the computer program product may include a non-transitory computer-readable medium storing instructions executable by a processor to cause the wireless communication apparatus to identify a source address, a destination address, or any combination thereof to be transmitted in a plain-text portion of a data frame and extract the identified source address, the identified destination address, or any combination thereof. The computer program product may include a non-transitory computer-readable medium storing instructions executable by a processor to cause the wireless communication apparatus to insert the extracted source address, the extracted destination address, or any combination thereof in a frame body of the data frame and encrypt the inserted source address, the inserted destination address, or any combination thereof in the frame body.

In a fifth set of illustrative examples, a method for wireless communication is described. In one configuration, the method includes receiving a data frame and determining that a source address, a destination address, or any combination thereof for the data frame is encrypted in a frame body of the data frame. The method may also include decrypting the frame body and identifying the source address, the destination address, or any combination thereof from the decrypted frame body.

In another example, identifying the source address, the destination address, or any combination thereof further includes identifying the source address, the destination address, or any combination thereof from a first portion of the decrypted frame body. In other examples, identifying the source address, the destination address, or any combination thereof further includes determining the source address from a first portion of the decrypted frame body and determining the destination address from a second portion of the decrypted frame body. In some examples of the method, the second portion comprises a first set of bits starting at a beginning of the frame body and the first portion comprises a second set of bits starting at an end of the first set of bits.

In some examples, the method further includes identifying a presence of the source address, the destination address, or any combination thereof from a frame control field of the data frame. The method may also include replacing an address field of a plain-text portion of the data frame with the source address. In another example, the method includes replacing an address field of a plain-text portion of the data frame with the destination address. In some examples, the plain-text portion of the data frame includes a medium access control (MAC) header of the data frame.

Determining that the source address, the destination address, or any combination thereof is encrypted may further include determining the source address, the destination address, or any combination thereof is encrypted from a security association with a transmitter of the data frame. In some examples, the security association comprises a 4-way handshake procedure.

In another example, determining that the source address, the destination address, or any combination thereof is encrypted further includes determining a presence of the source address, the destination address, or any combination thereof in the frame body from a syntax element associated with the data frame.

In another example, the method includes inserting the extracted source address, the extracted destination address, or any combination thereof in a frame header of the data frame. In yet another example, the method includes identifying an intermediary address based at least in part on the destination address, encapsulating the source address and the destination address in the frame body, encrypting the frame body, and transmitting the data frame according to the intermediary address.

In a sixth set of illustrative examples, another apparatus for wireless communication is described. In one configuration, the apparatus may include means for receiving a data frame and means for determining that a source address, a destination address, or any combination thereof for the data frame is encrypted in a frame body of the data frame. The apparatus may also include means for decrypting the frame body and means for identifying the source address, the destination address, or any combination thereof from the decrypted frame body.

In a seventh set of illustrative examples, another apparatus for wireless communication is described. In one configuration, the apparatus may include a receiver to receive a data frame and a MAC address privacy component to determine that a source address, a destination address, or any combination thereof for the data frame is encrypted in a frame body of the data frame. The apparatus may also include a frame body encryption component to decrypt the frame body and a MAC address update component to identify the source address, the destination address, or any combination thereof from the decrypted frame body. The MAC address update component may be further to identify the source address, the destination address, or any combination thereof from a first portion of the decrypted frame body.

In an eighth set of illustrative examples, a computer program product for communication by a wireless communication apparatus in a wireless communication system is described. In one configuration, the computer program product may include a non-transitory computer-readable medium storing instructions executable by a processor to cause the wireless communication apparatus to receive a data frame and determine that a source address, a destination address, or any combination thereof for the data frame is encrypted in a frame body of the data frame. The computer program product may also include a non-transitory computer-readable medium storing instructions executable by a processor to cause the wireless communication apparatus to decrypt the frame body and identify the source address, the destination address, or any combination thereof from the decrypted frame body.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows a swim lane diagram illustrating aspects of wireless communication, in accordance with various aspects of the present disclosure;

FIG. 3 shows another swim lane diagram illustrating aspects of wireless communication, in accordance with various aspects of the present disclosure;

FIG. 4 shows a block diagram illustrating aspects of a data frame, in accordance with various aspects of the present disclosure;

FIGS. 5-7 show block diagrams illustrating aspects of a frame body, in accordance with various aspects of the present disclosure;

FIG. 8 shows a block diagram of a device configured for use in wireless communication, in accordance with various aspects of the present disclosure;

FIG. 9 shows a block diagram of a device configured for use in wireless communication, in accordance with various aspects of the present disclosure;

FIG. 10 shows a block diagram of a wireless communication system, in accordance with various aspects of the present disclosure;

FIG. 11 shows a block diagram of an apparatus for use in wireless communication, in accordance with various aspects of the present disclosure;

FIG. 12 shows a block diagram of an apparatus for use in wireless communication, in accordance with various aspects of the present disclosure;

FIG. 13 shows a block diagram of a wireless station for use in wireless communication, in accordance with various aspects of the present disclosure;

FIG. 14 is a flow chart illustrating an example of a method for wireless communication, in accordance with various aspects of the present disclosure;

FIG. 15 is a flow chart illustrating an example of a method for transmitting a data frame in wireless communication, in accordance with various aspects of the present disclosure;

FIG. 16 is a flow chart illustrating an example of a method for wireless communication, in accordance with various aspects of the present disclosure; and

FIG. 17 is a flow chart illustrating an example of a method for receiving a data frame in wireless communication, in accordance with various aspects of the present disclosure.

### DETAILED DESCRIPTION

When a data frame is transmitted between wireless stations (STAs) or access points (APs), the data frames generally include address information identifying the transmitter and the receiver of the data frame. In some cases, where the data frame is to be transmitted between more than two STAs or APs, the data frames may also include address information identifying a source of the data frame and a destination of the data frame. The source and destination of the data frame are typically included in a plain-text portion of the data frame, in an address 3 field or an address 4 field. Being in the plain-text portion allows an observer to determine the identities of the source and the destination of the data frame. Techniques described herein protect the privacy of the source and the destination by removing those addresses from the plain-text portion and including them in an encrypted portion of the data frame.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

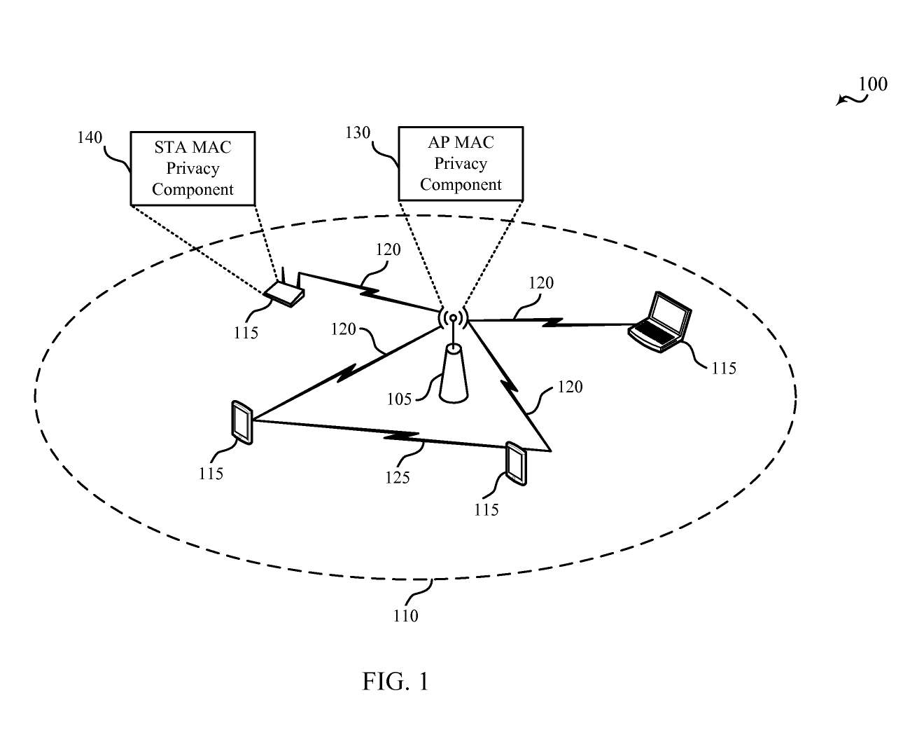

Referring first to FIG. 1, a block diagram illustrates an example of a WLAN network 100 such as, e.g., a network implementing at least one of the IEEE 802.11family of standards. The WLAN network 100 may include an access point (AP) 105 and at least one wireless device or station (STA) 115, such as mobile stations, personal digital assistants (PDAs), other handheld devices, netbooks, notebook computers, tablet computers, laptops, display devices (e.g., TVs, computer monitors, etc.), printers, and the like. While only one AP 105 is illustrated, the WLAN network 100 may have multiple APs 105. Each of the wireless stations 115, which may also be referred to as mobile stations (MSs), mobile devices, access terminals (ATs), user equipment (UE), subscriber stations (SSs), or subscriber units, may associate and communicate with an AP 105 via a communication link 120. Each AP 105 has a geographic coverage area 110 such that wireless stations 115 within that area can typically communicate with the AP 105. The wireless stations 115 may be dispersed throughout the geographic coverage area 110. Each wireless station 115 may be stationary or mobile.

A wireless station 115 can be covered by more than one AP 105 and can therefore associate with at least one AP 105 at different times. A single AP 105 and an associated set of stations may be referred to as a basic service set (BSS). An extended service set (ESS) is a set of connected BSSs. A distribution system (DS) is used to connect APs 105 in an extended service set. A geographic coverage area 110 for an access point 105 may be divided into sectors making up only a portion of the geographic coverage area 110. The WLAN network 100 may include access points 105 of different types (e.g., metropolitan area, home network, etc.), with varying sizes of coverage areas and overlapping coverage areas for different technologies. In other examples, other wireless devices can communicate with the AP 105.

While the wireless stations 115 may communicate with each other through the AP 105 using communication links 120, each wireless station 115 may also communicate directly with at least one other wireless station 115 via a direct wireless link 120. Two or more wireless stations 115 may communicate via a direct wireless link 120 when both wireless stations 115 are in the AP geographic coverage area 110 or when one or neither wireless station 115 is within the AP geographic coverage area 110. Examples of direct wireless links 120 may include Wi-Fi Direct connections, connections established by using a Wi-Fi Tunneled Direct Link Setup (TDLS) link, and other P2P group connections. The wireless stations 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, and the like. In other implementations, other peer-to-peer connections and/or ad hoc networks may be implemented within WLAN network 100.

The APs 105 may include an AP MAC privacy component 130 that manages aspects of privacy for wireless communications between the AP 105 and other APs 105 or the wireless stations 115. The AP MAC privacy component 130 may determine addresses of other APs 105 or wireless stations 115 located in a MAC header of a data frame and encrypt those addresses within a frame body of the data frame. The AP MAC privacy component 130 may encrypt addresses that are not required for an over-the-air (OTA) transmission of the data frame from the AP 105, such as a MAC address for an original source of the data frame or an ultimate destination of the data frame. The AP MAC privacy component 130 may also decrypt a frame body of a received data frame to determine addresses encrypted in a frame body of the data frame. The AP MAC privacy component 130 may update an address 3 field or an address 4 field of the data frame with the decrypted addresses.

Similarly, the wireless station 115 may include a STA MAC privacy component 140 that manages aspects of privacy for wireless communications between the wireless station 115 and an AP 105 or other the wireless stations 115. The STA MAC privacy component 140 may determine addresses of other APs 105 or wireless stations 115 located in a MAC header of a data frame and encrypt those addresses within a frame body of the data frame. That is, the STA MAC privacy component 140 may encrypt addresses that are not required for an over-the-air (OTA) transmission of the data frame from the wireless station 115, such as a MAC address for an original source of the data frame or an ultimate destination of the data frame. The STA MAC privacy component 140 may also decrypt a frame body of a received data frame to determine addresses encrypted in a frame body of the data frame. The STA MAC privacy component 140 may update an address 3 field or an address 4 field of the data frame with the decrypted addresses.

Accordingly, the wireless station 115 and the AP 105 may exchange data frames over communication links 120 where the data frames include the encrypted address 3 and address 4 fields. The wireless stations 115 may also exchange data frames over links 125 where the data frames include the encrypted address 3 and address 4 fields. The AP MAC privacy component 130 and the STA MAC privacy component 140 may perform a security association to inform a receiver of the data frame that the address 3 field or the address 4 field is encrypted.

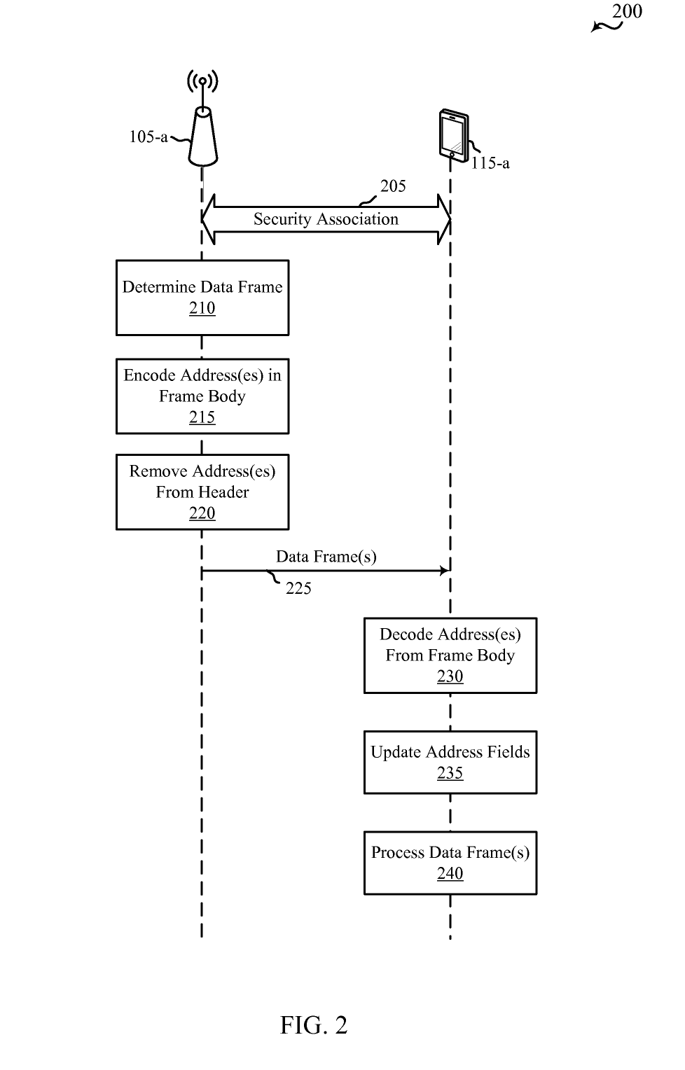

FIG. 2 shows a swim lane diagram 200 illustrating aspects of wireless communication, in accordance with various aspects of the present disclosure. The diagram 200 may illustrate aspects of the WLAN network 100 described with reference to FIG. 1. The diagram 200 includes a wireless station 115-a and an access point 105-a. The wireless station 115-a may be an example of at least one of the wireless stations 115 described above with respect to FIG. 1. The access point 105-a may be an example of at least one of the access points 105 described above with respect to FIG. 1. Generally, the diagram 200 illustrates aspects of MAC address privacy encrypting source and destination addresses in a frame body. In some examples, a system device, such as one of the wireless stations 115 and/or APs 105 may execute sets of codes to control the functional elements of the device to perform some or all of the functions described above and below.

At 205, the AP 105-a may perform a security association with the wireless station 115-a. The transmitter (e.g., the AP 105-a) may use the security association to indicate to the receiver (e.g., the wireless station 115-a) that at least one of the address 3 or address 4 is encrypted in a frame body for a data frame to be transmitted to the receiver. The security association may be a handshake. A security association may provide security between a transmitter and a receiver.

In one example, the security association is a 4-way handshake. A 4-way handshake may verify the existence of a same pairwise master key (PMK) between the transmitter (e.g., the AP 105-a in FIG. 2) and the receiver (e.g., the wireless station 115-a in FIG. 2) and to derive a pairwise transient key (PTK). The 4-way handshake may include four messages called message-1 through message-4. The presence of address 3 or address 4 encrypted in the frame body may be indicated in message-2 or message-3. In other examples, the security association may be a 3-way handshake or a 2-way handshake. In yet further examples, described below, the presence of address 3 or address 4 encrypted in the frame body may be indicated in other ways. The AP 105-a may send, transmit, or otherwise communicate the encrypted addresses, or information indicative of such addresses, to the wireless station 115-a. In one example, the handshake uses a reversed bit in a robust security network (RSN)/RSN element (RSNE) capability or in an extensible authentication protocol (EAPOL)-Key frame.

At block 210, the AP 105-a may determine a data frame to be transmitted. The data frame may be a Wi-Fi data packet, for example. A data frame may include a preamble portion (e.g., a header or plain-text portion) and a payload portion (e.g., a payload or frame body). The data frame may include a MAC header. In other examples, the data frame conforms to a different standard or protocol. The AP 105-a may receive the data frame from another device or may generate the data frame itself. The data frame may have values for an address 3 field or an address 4 field. The address 3 field may indicate a source address or a destination address. The address 4 field may indicate a source address. In some cases, the address 3 field is present while the address 4 field is not present.

The data frame may have address information that is not directly used for over-the-air transmitting and receiving. The address information may be at least one of a source address and a destination address. At block 215, the AP 105-a may encode the addresses in a frame body of the data frame. For example, if the AP 105-a received the data frame from another AP 105 or wireless station 115, the data frame may include an address field that identifies a source of the data frame. A source of the data frame may be an originator of the data frame. A destination of the data frame may be an ultimate intended recipient of the data frame. In some examples, the source address and the destination address may be any transmitting or receiving device along a transmission chain of the data frame. By encoding the addresses in the frame body, an unintended recipient or eavesdropper may not be able to determine the source or destination address of the data frame.

At block 220, the AP 105-a may remove the address 3 or address 4 from the frame header (e.g., the plain-text portion of the data frame). In one example, the AP 105-a may replace either or both of the address 3 field and the address 4 field with a fixed value that does not identify the source or destination address. In some examples, the fixed value may be all zeros. In another example, the AP 105-a may remove either or both of the address 3 field and the address 4 field from the data frame.

The AP 105-a may transmit the data frame 225 to the wireless station 115-a. In some examples, the AP 105-a transmits more than one data frame 225 to the wireless station 115-a. The data frame 225 may include a plain-text portion and a frame body portion. The plain-text portion may be unencrypted, and may be a MAC header. The frame body portion may be encrypted and carry the payload of the data frame, as well as the encrypted address 3 or address 4. The data frame 225 may be transmitted using over-the-air wireless transmissions.

Upon receiving the data frame 225, at block 230, the wireless station 115-a may decode the frame body, including decoding the address 3 or address 4. The wireless station 115-a may know to look for the address 3 or address 4 from the security association. In other examples, described below, the wireless station 115-a may determine address 3 or address 4 are encrypted in the frame body by other means.

At block 235, the wireless station 115-a may update at least one of the address 3 and address 4 fields with the decrypted address values. For example, the wireless station 115-a may decrypt a value of an address 4 from the encrypted frame body and cut and paste the value into the address 4 field of the frame header. Similarly, the wireless station 115-a may decrypt a value of an address 3 from the encrypted frame body and cut and paste the value into the address 3 field of the frame header.

The wireless station 115-a may process the data frame accordingly at block 240. For example, if the wireless station 115-a is the ultimate destination for the data frame, the wireless station 115-a may use the data frame. If the wireless station 115-a is not the ultimate destination for the data frame, the wireless station 115-a may transmit the data frame to another wireless station 115 or AP 105 to get the data frame to the destination. If the wireless station 115-a does transmit the data frame, the wireless station 115-a may protect the privacy of the address 3 or address 4 information according to techniques described herein.

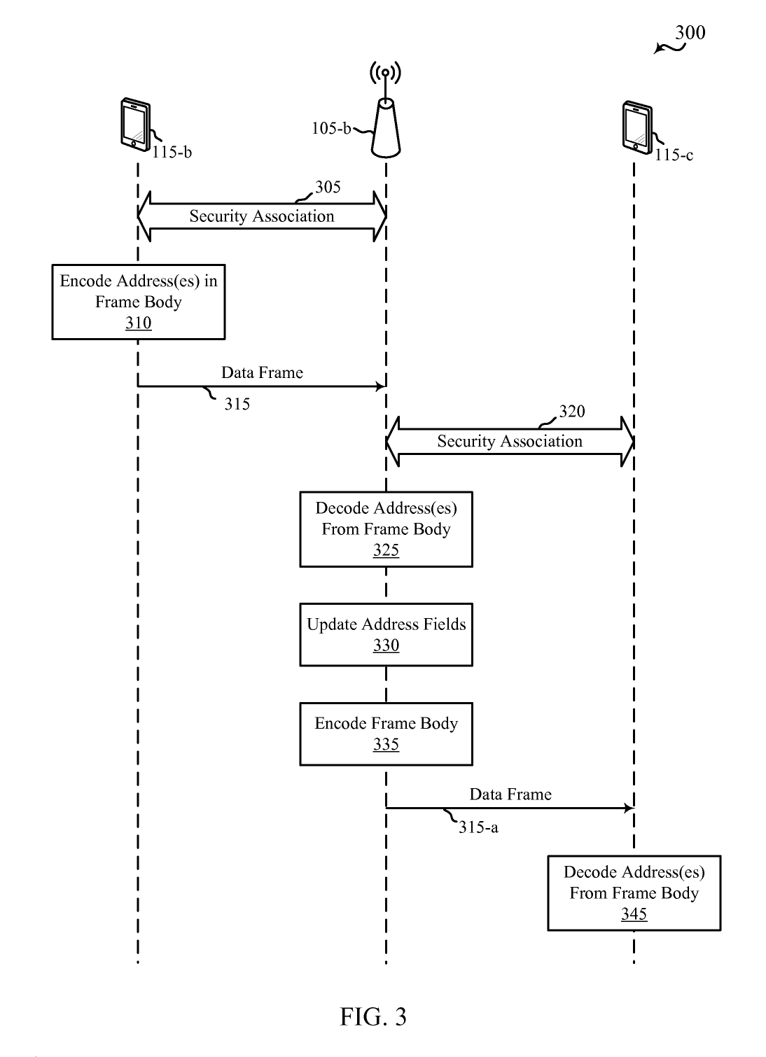

FIG. 3 shows another swim lane diagram 300 illustrating aspects of wireless communication, in accordance with various aspects of the present disclosure. The diagram 300 may illustrate aspects of the WLAN network 100 described with reference to FIG. 1. The diagram 300 includes a wireless station 115-b, an access point 105-b, and another wireless station 115-c. The wireless stations 115-b and 115-c may be examples of at least one of the wireless stations 115 described above with respect to FIGS. 1 and 2. The access point 105-b may be an example of at least one of the access points 105 described above with respect to FIGS. 1 and 2. Generally, the diagram 300 illustrates aspects of MAC address privacy encrypting source or destination addresses in a frame body. In some examples, a system device, such as one of the wireless stations 115 and/or APs 105 may execute sets of codes to control the functional elements of the device to perform some or all of the functions described above and below.

FIG. 3 illustrates an example where a data frame 315 is relayed through two transmitting devices (e.g., the wireless station 115-b and the AP 105-b) to a receiver (e.g., the wireless station 115-c). For brevity, steps similar to those in FIG. 2 may not be discussed in detail. For illustrated purposes, the example of FIG. 3 is described as the wireless station 115-b being a source of the data frame and the wireless station 115-c being a destination of the data frame 315. However, in other examples, other devices may be the source or destination of the data frame 315. In some examples, the data frame 315 may be an example of at least one aspect of the data frame 225 of FIG. 2.

The wireless station 115-b generates a data frame 315 for transmission. The data frame 315 is intended for the wireless station 115-c. Thus, in this example, the source address identifies the wireless station 115-b and the destination address identifies the wireless station 115-c. The wireless station 115-b may determine that at least one intermediary wireless station may be used to transmit the data frame to the destination. In the example of FIG. 3, the AP 105-b may be used as an intermediary to receive the data frame 315 from the wireless station 115-b and transmit it as the data frame 315-a to the wireless station 115-c.

The wireless station 115-b and the AP 105-b may perform a security association 305. The wireless station 115-b may indicate to the AP 105-b, via the security association 305, the capability of the wireless station 115-b to encode and decode address fields in a frame body of a data frame. Likewise, the AP 105-b may indicate to the wireless station 115-b, via the security association 305, the capability of the AP 105-b to encode and decode address fields in a frame body of a data frame. The AP 105-b may transmit the data frame 315 to the wireless station 115-c.

At block 310, the wireless station 115-b may encode, if present in the data frame 315, an address 3 and an address 4 in the frame body. Since the wireless station 115-b is the source of the data frame 315, the wireless station 115-b will be identified in the plain-text portion of the data frame 315 regardless. However, the wireless station 115-c may be identified as the destination address in the address 3 field. If only the destination address is present, the destination address may be stored in the address 3 field of the plain-text portion of the data frame 315. Therefore, the wireless station 115-b may encrypt the destination address in the frame body of the data frame 315.

The wireless station 115-b may be identified as the transmitter and the AP 105-b may be identified as the receiver in the plain-text portion of the data frame 315. The wireless station 115-b may transmit the data frame 315 to the AP 105-b.

At block 325, the AP 105-b may decode the frame body and determine the destination address. At block 330, the AP 105-b may update the address fields in the plain-text portion to reflect the encrypted addresses. In this example, the AP 105-b may modify the address 3 field of the plain-text portion to include the destination address. Once the data frame 315 is restored in this way, the AP 105-b may determine what device to forward the data frame 315. The destination address identifies the wireless station 115-c as the destination of the data frame 315. The AP 105-b may determine whether it can transmit the data frame 315 to the wireless station 115-c directly or if it needs to transmit the data frame 315 to another device. In this example, the AP 105-b determines it can transmit the data frame 315 to the wireless station 115-c directly. For over-the-air purposes, the AP 105-b is identified as the transmitting device and the wireless station 115-c is identified as the receiving device. However, now the source address will identify the wireless station 115-b. Therefore, the address for the wireless station 115-b may be in address 3.

The AP 105-b may be identified as the transmitter and the wireless station 115-c may be identified as the receiver in the plain-text portion of the data frame 315-a. The AP 105-b and the wireless station 115-c may perform a security association 320. The AP 105-b may indicate to the wireless station 115-c, via the security association 320, the capability of the AP 105-b to encode and decode address fields in a frame body of a data frame. Likewise, the wireless station 115-c may indicate to the AP 105-b, via the security association 320, the capability of the wireless station 115-c to encode and decode address fields in a frame body of a data frame.

At block 335, the AP 105-b encodes the frame body of the data frame 315-a. The AP 105-b may hide the source address (e.g., the address for the wireless station 115-b) from the plain-text address 3 field in the encoded frame body. The AP 105-b may delete the address 3 field from the plain-text portion or may replace the address with a fixed value, such as all zeros. The date frame 315-a may be an example of the data frame 315 with updated address fields. In some examples, the data frame 315-a may be an example of at least one aspect of the data frame 220 or 315 of FIGS. 2-3. The AP 105-b may transmit the data frame 315-a to the wireless station 115-c.

Upon receiving the data frame 315-a, the wireless station 115-c may decode the address 3 from the frame body at block 345. The wireless station 115-c may then update the plain-text portion of the data frame 315-a with the address 3. The wireless station 115-c may proceed with processing the received data frame 315-a.

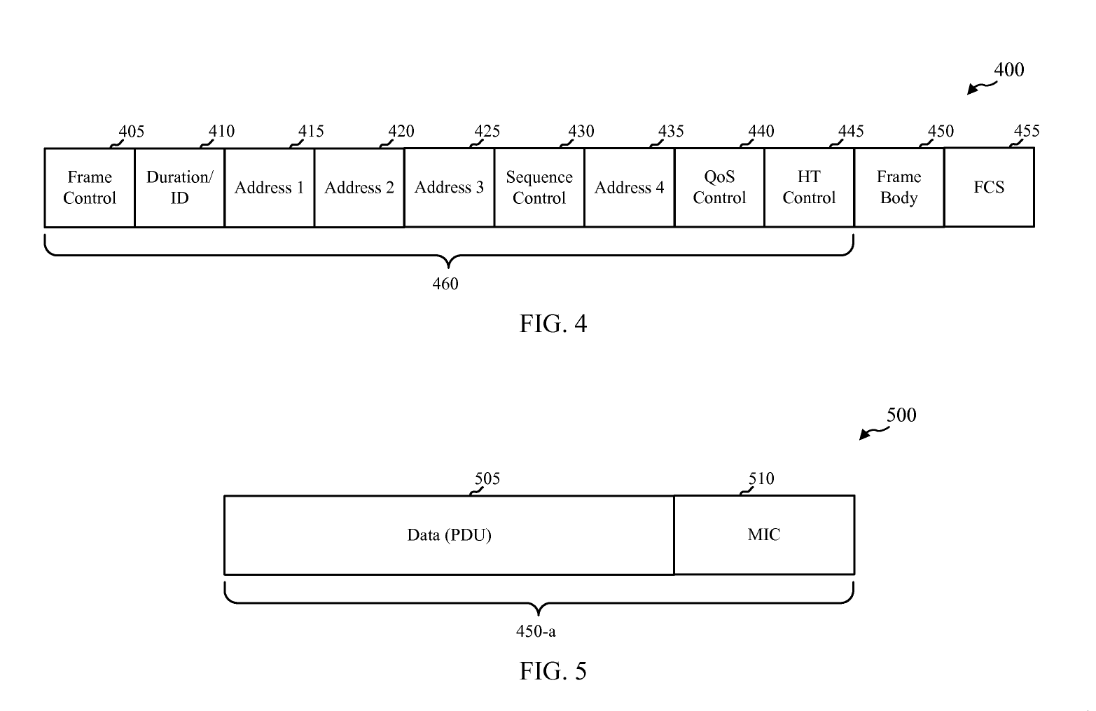

FIG. 4 shows a block diagram illustrating aspects of a data frame 400, in accordance with various aspects of the present disclosure. The data frame 400 may illustrate aspects of the data frames 225 and 315 described with reference to FIGS. 2 and 3. The data frame 400 may be transmitted between at least one wireless station 115 and access point 105, such as at least one of the wireless stations 115 described above with respect to FIGS. 1 and 2 and the access points 105 described above with respect to FIGS. 1-3.

In some examples, the data frame 400 is a Wi-Fi data packet. The data frame 400 may include a plain-text portion 460. The plain-text portion 460 may be a header or a preamble, such as a MAC header. The plain-text portion 460 may not be encrypted and may be read by an observer or eavesdropper of the data frame 400. The data frame 400 may also include a frame body 450, which may carry a payload of the data frame 400. The frame body 450 may be encrypted. In some examples, the data frame 400 is a Wi-Fi data frame 400 that includes a MAC header (e.g., plain-text portion 460), a payload (e.g., frame body 450), and a frame check sequence (FCS) 455.

The data frame 400 may include a frame control field 405. The frame control field 405 may specify a form and function of the data frame 400. The frame control field 405 may be an 8-bit field that may include one bit to for a ToDS subfield and another bit for a FromDS subfield. The ToDS and FromDS fields indicate whether the data frame 400 is headed for or from a distribution system (DS). The data frame 400 may also include a duration/ID field 410. The duration/ID field 410 may be two bytes that can include a duration, a contention-free period (CFP), and an association ID (AID).

The data frame 400 may also include up to four address fields: an address 1 field 415, an address 2 field 420, an address 3 field 425, and an address 4 field 435. The address fields 415, 420, 425, and 435 may each include a MAC address. The address 1 field 415 may include a MAC address for the receiver of the over-the-air transmission of the data frame 400. The address 1 field 415 may be present for all data frames 400. The address 2 field 420 may include a MAC address for the transmitter of the over-the-air transmission of the data frame 400. The address 2 field 420 may be present for all data frames 400 except acknowledgement (ACK) and clear-to-send (CTS) frames. The address 3 field 425 may be used to include a basic service set (BSS) identification (BSSID), a source address (SA), or a destination address (DA). The address 3 field 425 may be dependent on the ToDS and FromDS bit settings and whether the frame is carrying a MAC service data unit (MSDU) or an aggregate MAC service data unit (A-MSDU). A receiver may use the address 3 field 425 for filtering purposes. In some examples, the address 4 field 435 may include a BSSID or a source address. The address 4 field 435 may only be present in data frames and only when both the To DS and the From DS bits are set. In other examples, the address 4 field 435 may be non-applicable (N/A) and either not be included in the data frame 400 or have a blank or fixed value.

Table 1 illustrates example address field contents for 802.11. Table 1 illustrates the address fields for the four possible combinations of the To/From DS field values for the example of the IEEE standard 802.11.

TABLE 1

| | | | | Address 3 | | Address 4 | |
|---|---|---|---|---|---|---|---|
| | From | | | MSDU | A-MSDU | MSDU | A-MSDU |
| ToDS | DS | Address 1 | Address 2 | case | case | case | case |
| 0 | 0 | RA = DA | TA = SA | BSSID | BSSID | N/A | N/A |
| 0 | 1 | RA = DA | TA = BSSID | SA | BSSID | N/A | N/A |
| 1 | 0 | RA = BSSID | TA = SA | DA | BSSID | N/A | N/A |
| 1 | 1 | RA | TA | DA | BSSID | SA | BSSID |

In the first row, both ToDS and FromDS are 0. This may indicate that the data frame 400 is being sent directly from one station to another within the same independent basic service set (IBSS), the data frame is direct from one wireless station 115 to another wireless station 115 within the same BSS, or that the data frame 400 is a management or control frame. For purposes of this disclosure, the data frame 400 is being sent from the source to the destination in this example. In this case, the address 1 field 415 includes the receiver address (RA), which is the same as the destination address (DA), and the address 2 field 420 includes the transmitter address (TA), which is the same as the source address (DA) in this example. What is stored in the address 3 field 425 and the address 4 field 435 may depend on what type of service data unit is used. The two cases may be for the MSDU or the A-MSDU. In the example of the first row, the address 3 field 425 includes the BSSID and the address 4 field 435 is not used, regardless of the service data unit. For every example A-MSDU case, the address 3 field 425 includes the BSSID and the address 4 field 435 either is not used or includes the BSSID.

In the second row of Table 1, the ToDS is set to 0 and the FromDS is set to 1. This means that the data frame 400 may be destined to a distribution system or is sent from a wireless station 115 associated with an AP 105 to a Port Access Entity in that AP 105. For example, the data frame 400 came from some other source and is now being transmitted to its destination. In this case, the address 1 field 415 includes the receiver address, which is the same as the destination address. The address 2 field 420 includes the transmitter address, which is the same as the BSSID in this example. For the MSDU case, the address 3 field 425 includes the source address, which identifies the source of the data frame 400. The address 4 field 435 is not used. In this example, an observer of the transmission of the data frame 400 may be able to determine the source address from the address 3 field 425 in the plain-text portion if the address 3 field 425 identifies the source address. According to techniques described herein, the wireless station 115 or the AP 105 may remove the source address from the address 3 field 425 and encrypt it in the frame body 450.

In the third row, the data frame 400 is being sent to a distribution system but is not coming from a distribution system, so ToDS is set to 1 and FromDS is set to 0. That is, the data frame 400 is at the source and is now being transmitted through another receiver before it arrives at its destination. In this case, the address 1 field 415 includes the receiver address, which is the same as the BSSID. The address 2 field 420 includes the transmitter address, which is the same as the source address. For the MSDU case, the address 3 field 425 includes the destination address, which identifies the ultimate destination of the data frame 400. The address 4 field 435 is not used. In this example, an observer of the transmission of the data frame 400 may be able to determine the destination address from the address 3 field 425 in the plain-text portion if the address 3 field 425 identifies the destination address. According to techniques described herein, the wireless station 115 or AP 105 may remove the destination address from the address 3 field 425 and encrypt it in the frame body 450.

In the fourth row of Table 1, both ToDS and FromDS are set to 1, meaning the data frame 400 uses the four-address format. For example, the transmitter sending the data frame 400 may have received the data frame from another transmitter and is now sending the data frame to a receiver that is not the destination. In this case, the address 1 field 415 includes the receiver address for the intermediary receiver. The address 2 field 420 includes the transmitter address for the intermediary transmitter. For the MSDU case, the address 3 field 425 includes the destination address, which identifies the ultimate destination of the data frame 400. The address 4 field 435 includes the source address, which identifies the original source of the data frame 400. In this example, an observer of the transmission of the data frame 400 may be able to determine the destination address and the source address from the address 3 field 425 and the address 4 field 435, respectively, if the addresses are included in the plain-text portion. According to techniques described herein, the wireless station 115 or AP 105 may remove the destination address from the address 3 field 425 and the source address from the address 4 field 435 and encrypt them in the frame body 450 to increase privacy.

The data frame 400 may also include a sequence control field 430. The sequence control field 430 may be a two-byte section that is used for identifying a message order or eliminating duplicate frames. In additional examples, the data frame 400 also includes a quality of service (QoS) control field 440 and a high throughput (HT) control field 445. The QoS control field 440 may be a two-byte field that identifies a traffic class (TC) or traffic stream (TS) to which the data frame 400 belongs.

The data frame 400 may also include the FCS 455. The FCS 455 may be the last four bytes in the data frame 400. The FCS 455 may also be referred to as a cyclic redundancy check (CRC) that allows for integrity check of retrieved frames.

The data frame 400 also includes the frame body 450. The frame body 450 may be the payload portion of the data frame 400 and may contain information specific to the individual frame type and subtypes of the frame 400. The frame body 450 may be variable in size, from 0 to 2304 bytes plus overhead from security encryption. The frame body 450 may include the address 3 and address 4 information to protect the information from exposure in the plain-text portion 460. At times, addresses, such as address 3 and address 4, may not be extracted from the plain-text portion 460, or may be extracted from elsewhere. In some cases, a source may not need to extract addresses, such as address 3 or address 4, and may construct a MAC frame. For example, a MAC frame may be constructed by inserting addresses, such as address 3 or address 4, into a frame body, such as the frame body 450.

FIG. 4 represents one example of a data frame 400. In other examples, other data frames may be used. The content and format of the data frame 400 may vary. Further, the bit lengths of the fields described herein merely represent one example. In other examples, other field lengths may be used.

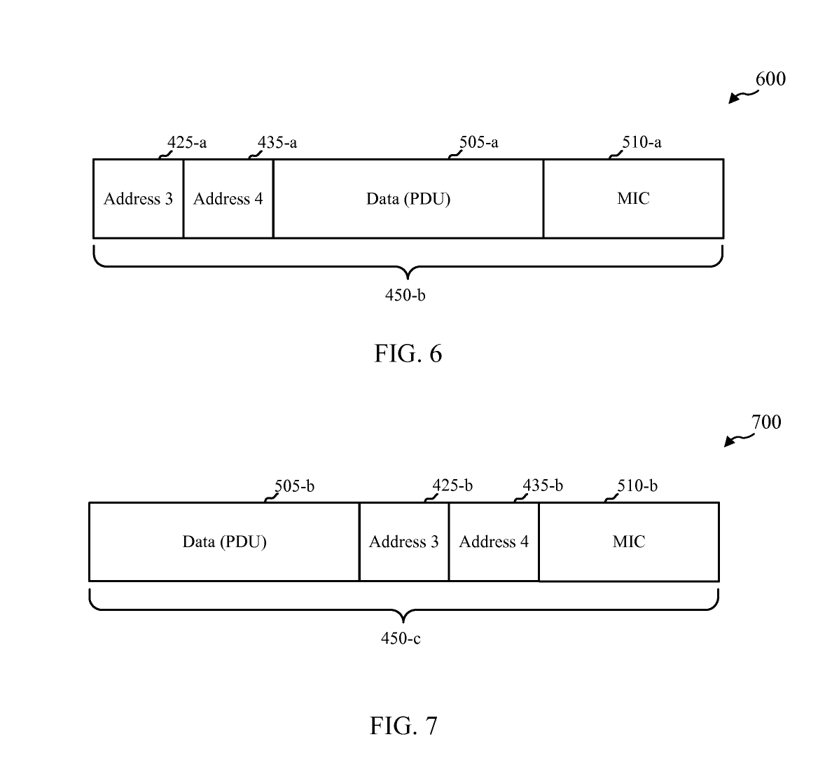

FIG. 5 shows a block diagram 500 illustrating aspects of a frame body 450-a, in accordance with various aspects of the present disclosure. The frame body 450-a may illustrate aspects of the frame body 450 described with reference to FIG. 4. The frame body 450-a includes two subfields: a data subfield 505 and a message integrity code (MIC) subfield 510. The data subfield 505 may also be referred to as a protocol data unit (PDU) or a payload. The MIC subfield 510 may provide data origin authentication and data integrity for the payload data (e.g., the data subfield 505).

If present, the data subfield 505 may include the values for address 3 and address 4, such as the address 3 field 425 and the address 4 field 435 of FIG. 4. In such an example, the address 3 field 425 and the address 4 field 435 would not contain the actual values for the addresses. Instead, in one example, the plain-text portion 460 would not include the address 3 field 425 nor the address 4 field 435 at all. In another example, the plain-text portion 460 does include the address 3 field 425 and the address 4 field 435, but they include incorrect or misleading values. The data subfield 505 may be encrypted before the data frame is transmitted. A receiver of the data frame may decrypt the data subfield 505 to determine the values of the address 3 or the address 4 fields.

FIG. 6 shows a block diagram 600 illustrating aspects of a frame body 450-b, in accordance with various aspects of the present disclosure. The frame body 450-b may illustrate aspects of the frame bodies 450 described with reference to FIGS. 4 and 5. The frame body 450-b includes a data subfield 505-a and a MIC subfield 510-a. The data subfield 505-a may illustrate aspects of the data subfield 505 described with reference to FIG. 5. The MIC subfield 510-a illustrate aspects of the MIC subfield 510 described with reference to FIG. 5.

If present, the frame body 450-b may include the address 3 field 425-a. The address 3 field 425-a may illustrate aspects of the address 3 field 425 described with reference to FIG. 4. The address 3 field 425-a may include a source address or a destination address. In some examples, the frame body 450-b may include the address 4 field 435-a if the address 4 is present (e.g., when ToDS=1 and FromDS=1 in the Frame Control Field 405 of FIG. 4). The address 4 field 435-a may include a source address. The address 4 field 435-a may illustrate aspects of the address 4 field 435 described with reference to FIG. 4.

As shown in FIG. 6, the address 3 field 425-a and the address 4 field 435-a may be prepended to the beginning of the frame body 450-b. For example, the address 3 field 425-a and the address 4 field 435-a may be prepended to the beginning of the data subfield 505-a. In some examples, the address 3 field 425-a and the address 4 field 435-a may be appended to the beginning of the frame body 450-b in the same order that they appear in the MAC header 460. In other examples, the address 3 field 425-a and the address 4 field 435-a may be appended to the beginning of the frame body 450-b in a different order that they appear in the MAC header 460. If the address fields 425-a and 435-a are in reverse order, the transmitter may indicate the order to the receiver. In some examples, the address 3 field 425-a is included in the frame body 450-b but the address 4 field 435-a is not included. Using this technique, address 3 and address 4 may be hidden in an 802.11 data frame to enhance over-the-air message privacy.

FIG. 7 shows a block diagram 700 illustrating aspects of a frame body 450-c, in accordance with various aspects of the present disclosure. The frame body 450-c may illustrate aspects of the frame bodies 450 described with reference to FIGS. 4-6. The frame body 450-c includes a data subfield 505-b and a MIC subfield 510-b. The data subfield 505-b may illustrate aspects of the data subfield 505 described with reference to FIGS. 5 and 6. The MIC subfield 510-b illustrate aspects of the MIC subfield 510 described with reference to FIGS. 5 and 6.

The frame body 450-c may include the address 3 field 425-b. The frame body 450-c may include the address 3 field 425-b when, for example, the address 3 field 425-b contains a source or a destination address. The address 3 field 425-b may illustrate aspects of the address 3 field 425 described with reference to FIGS. 4 and 6. The address 3 field 425-b may include a source address or a destination address.

In some examples, the address 4 field is present in the data frame (e.g., when ToDS=1 and FromDS=1 in the Frame Control Field 405 of FIG. 4). In such cases, the frame body 450-c may include the address 4 field 435-b. The address 4 field 435-b may include a source address. The address 4 field 435-b may illustrate aspects of the address 4 field 435 described with reference to FIGS. 4 and 6. FIG. 7 illustrates an example of when the address 4 field 435 is present. In other examples, the address 4 field 435 may not be present.

As shown in FIG. 7, the address 3 field 425-b and the address 4 field 435-b may be prepended to the end of the frame body 450-c. For example, the address 3 field 425-b and the address 4 field 435-b may be prepended to the end of the data subfield 505-b. In some examples, the address 3 field 425-b and the address 4 field 435-b may be appended to the end of the data subfield 505-b in the same order that they appear in the MAC header 460. In other examples, the address 3 field 425-b and the address 4 field 435-b may be appended to the end of the data subfield 505-b in a different order that they appear in the MAC header 460. If the address fields 425-b and 435-b are in reverse order, the transmitter may indicate the order to the receiver. In some examples, the address 3 field 425-b is included in the frame body 450-c but the address 4 field 435-b is not included, such as when address 4 is not present. Using this technique, address 3 and address 4 may be hidden in an 802.11 data frame to enhance over-the-air message privacy.

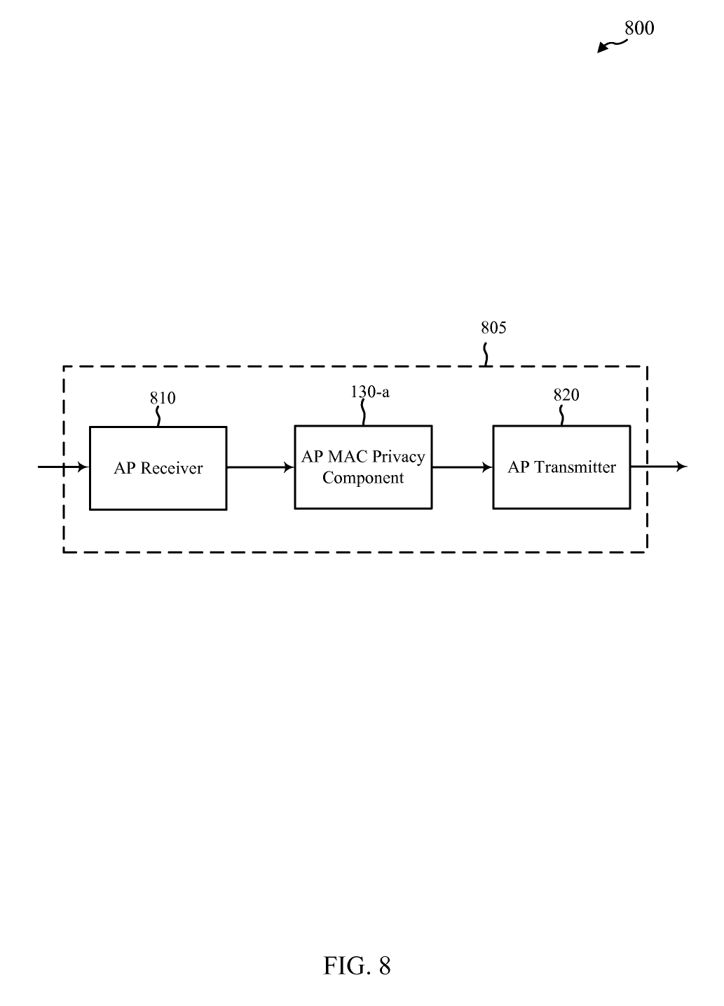

FIG. 8 shows a block diagram 800 of a device 805 for use in an AP for wireless communication, in accordance with various aspects of the present disclosure. The device 805 may be an example of at least one aspect of an AP 105 described with reference to FIGS. 1-3. The device 805 may include an AP receiver 810, an AP MAC privacy component 130-a, and/or an AP transmitter 820. The device 805 may also be or include a processor. Each of these modules may be in communication with each other.

The device 805, through the AP receiver 810, the AP MAC privacy component 130-a, and/or the AP transmitter 820, may be configured to perform functions described herein. For example, the device 805 may be configured to manage aspects of securing an address 3 field or an address 4 field in a frame body of a data frame.

The components of the device 805 may, individually or collectively, be implemented using at least one application-specific integrated circuit (ASIC) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by at least one general or application-specific processor.

The AP receiver 810 may receive information such as packets, user data, and/or control information associated with various information channels (e.g., control channels, data channels, etc.). The AP receiver 810 may be configured to receive data frames where an address 3 or an address 4 is encrypted in a frame body. The AP receiver 810 may also be configured to receive signals for a security association or a syntax element indicating that the address 3 or the address 4 is encrypted in a frame body. Information may be passed on to the AP MAC privacy component 130-a, and to other components of the device 805.

The AP MAC privacy component 130-a may be an example of at least one aspect of the AP MAC privacy component 130 described with reference to FIG. 1. The AP MAC privacy component 130-a may function differently depending on whether the device 805 is transmitting or receiving a data frame according to techniques described herein.

When the device 805 is receiving a data frame, the AP MAC privacy component 130-a may perform a security association with the transmitter. The security association may inform the AP MAC privacy component 130-a that at least an address 3 is encrypted in a frame body of a data frame to be transmitted by the transmitter. In other examples, the AP MAC privacy component 130-a determines the presence of the addresses in the frame body based on the ToDS and FromDS values in the frame control field. In some examples, the security association also informs the AP MAC privacy component 130-a of where in the frame body the addresses are stored. The AP receiver 810 may receive the data frame and provide it to the AP MAC privacy component 130-a. The AP MAC privacy component 130-a may decrypt the frame body.

Once decrypted, the AP MAC privacy component 130-a may determine the address 3 or the address 4 from the decrypted frame body. In one example, the AP MAC privacy component 130-a cuts a first portion of the frame body (e.g., the first six octets) and pastes it into an address 3 field of the frame header. If the address 4 is present, the AP MAC privacy component 130-a cuts a second portion of the frame body (e.g., the next six octets) and pastes it into an address 4 field of the frame header. Thus, the AP MAC privacy component 130-a recreates the typical MAC frame header format. In some examples, the first portion is the first six octets of the frame body and the second portion is the second six octets of the frame body. In another example, the second portion is the last six octets of the frame body and the first portion is the next-to-last six octets of the frame body. In another example, if EUI-64 is used for the MAC addresses, AP MAC privacy component 130-a takes eight octets for the address 3 and address 4 fields.

When the device 805 is transmitting a data frame, the AP MAC privacy component 130-a may perform a security association with the receiver. The security association may inform the receiver that at least an address 3 is encrypted in a frame body of a data frame to be received by the receiver. In some examples, the AP MAC privacy component 130-a also uses the security association to inform the receiver of where in the frame body the addresses are stored.

Before encrypting the frame body, the AP MAC privacy component 130-a may copy the address 3 and the address 4 (if present) from the frame header and prepend them to the frame body. In one example, the AP MAC privacy component 130-a prepends the addresses in the same order. In some examples, the AP MAC privacy component 130-a may prepend the addresses in a reverse order, as long as the receiver can determine the order. The AP MAC privacy component 130-a may add the address 3 and address 4 to the beginning or the end of the frame body.

The AP MAC privacy component 130-a may set the address 3 field and, if present, the address 4 field in the plain-text portion of the data frame (e.g., MAC header) to a fixed value. In one example, the fixed value is all zeros. In another example, the AP MAC privacy component 130-a deletes the address 3 field and the address 4 field from the plain-text portion of the data frame. Next, the AP MAC privacy component 130-a may encrypt the frame body, including the added address 3 and, if present, address 4. That is, the AP MAC privacy component 130-a starts or ends the encryption of the frame body from the prepended address 3 or the prepended addresses 3 and 4. The AP MAC privacy component 130-a may provide the encrypted data frame to the AP transmitter 820.

The AP transmitter 820 may transmit the at least one signal received from other components of the device 805. The AP transmitter 820 may transmit the encrypted data frame according to the address 1 field of the plain-text portion. In some examples, the AP transmitter 820 may be collocated with the AP receiver 810 in an AP transceiver.

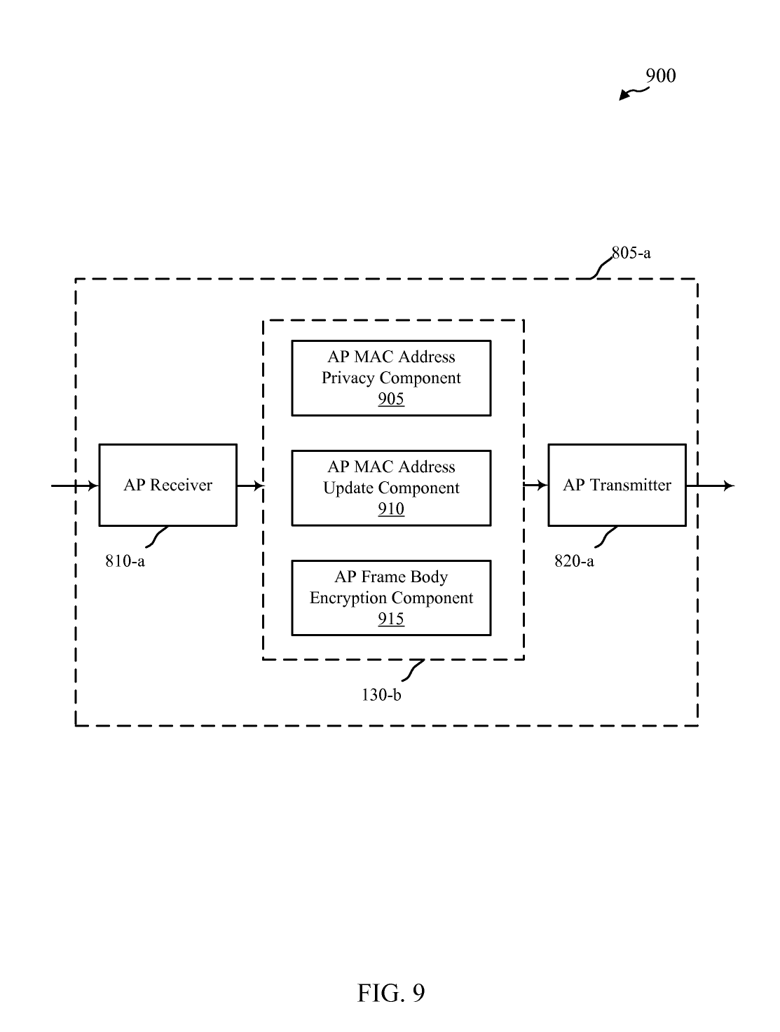

FIG. 9 shows a block diagram 900 of a device 805-a that is used in an AP for wireless communication, in accordance with various examples. The device 805-a may be an example of at least one aspect of an AP 105 described with reference to FIGS. 1-3. It may also be an example of a device 805 described with reference to FIG. 8. The device 805-a may include an AP receiver 810-a, an AP MAC privacy component 130-a, and an AP transmitter 820-a, which may be examples of the corresponding components of device 805. The device 805-a may also include a processor. Each of these components may be in communication with each other. The AP MAC privacy component 130-a may include an AP MAC address privacy component 905, an AP MAC address update component 910, and an AP frame body encryption component 915. The AP receiver 810-a and the AP transmitter 820-a may perform the functions of the AP receiver 810 and the AP transmitter 820, of FIG. 8, respectively.

The AP MAC address privacy component 905 may protect the privacy of a source and destination address of a data frame by hiding them in a frame body of the data frame. The AP MAC address privacy component 905 may identify an address 3 and an address 4 in a MAC header or in a decrypted frame body. The AP MAC address privacy component 905 may copy the address 3 and, if present, the address 4 from the MAC address and insert them into the frame body according to examples described herein. The AP MAC address privacy component 905 may also perform security associations with the receiver of the data frame. The AP MAC address privacy component 905 may inform the receiver that the address 3 and 4 fields are hidden in the frame body.

The AP MAC address update component 910 may protect the privacy of a source and destination address of a data frame by removing them from a plain-text portion of the data frame. Once the address values are located in the frame body, the AP MAC address update component 910 may modify the address 3 and address 4 fields in the MAC header. The AP MAC address update component 910 may replace the addresses with fixed values or remove the address fields from the plain-text portion of the data frame.

The AP MAC address update component 910 may also replace the source and destination addresses of a data frame by removing them from the frame body and pasting them in the appropriate address fields of the plain-text portion of the data frame. The AP MAC address update component 910 may determine where the address 3 and the address 4 are located in the frame body. The AP MAC address update component 910 may reconstruct the MAC header by locating the addresses, cutting the values, and replacing them in the address fields.

The AP frame body encryption component 915 may encrypt the frame body to prepare the data frame for transmission. The AP frame body encryption component 915 may encrypt the address 3 and address 4 portions of the frame body. The AP frame body encryption component 915 may also decrypt frame bodies of received data frames.

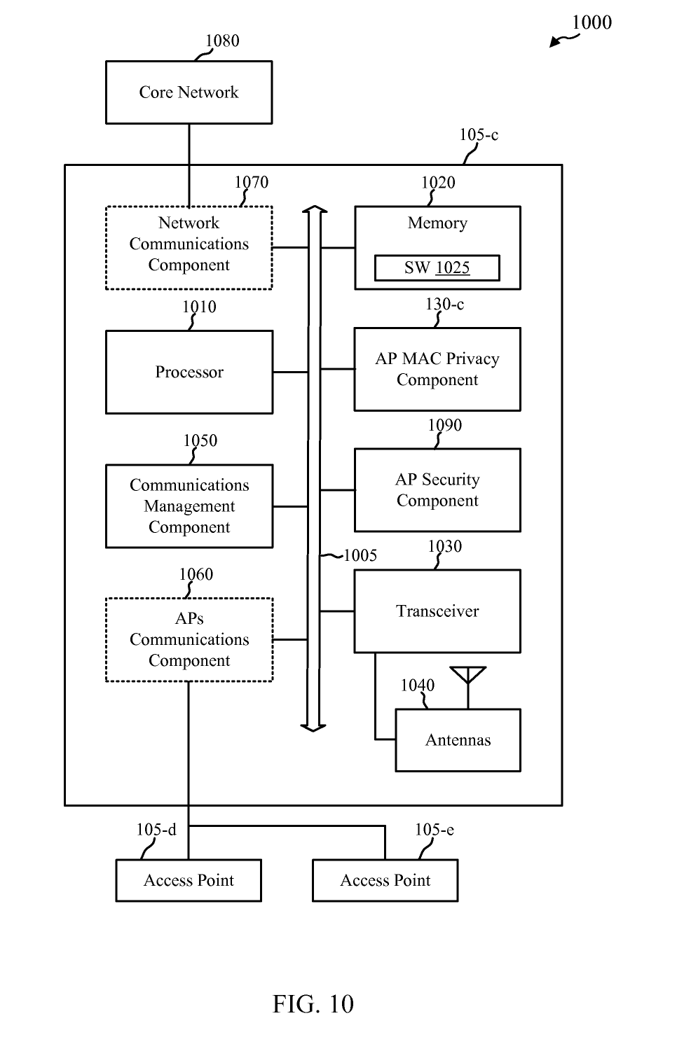

Turning to FIG. 10, a diagram 1000 is shown that illustrates an access point or AP 105-c configured for MAC address privacy. In some aspects, the AP 105-c may be an example of the APs 105 of FIGS. 1-3. The AP 105-c may include a processor 1010, a memory 1020, a transceiver 1030, antennas 1040, and an AP MAC privacy component 130-c. The AP MAC privacy component 130-c may be an example of the AP MAC privacy component 130 of FIGS. 1 and 8-9. In some examples, the AP 105-c may also include one or both of an APs communications component 1060 and a network communications component 1070. Each of these components may be in communication with each other, directly or indirectly, over at least one bus 1005.

The memory 1020 may include random access memory (RAM) and read-only memory (ROM). The memory 1020 may also store computer-readable, computer-executable software (SW) code 1025 containing instructions that are configured to, when executed, cause the processor 1010 to perform various functions described herein for generating or removing source and destination addresses from frame bodies, for example. Alternatively, the software code 1025 may not be directly executable by the processor 1010 but be configured to cause the computer, e.g., when compiled and executed, to perform functions described herein.

The processor 1010 may include an intelligent hardware device, e.g., a central processing unit (CPU), a microcontroller, an ASIC, etc. The processor 1010 may process information received through the transceiver 1030, the APs communications component 1060, and/or the network communications component 1070. The processor 1010 may also process information to be sent to the transceiver 1030 for transmission through the antennas 1040, to the APs communications component 1060, and/or to the network communications component 1070. The processor 1010 may handle, alone or in connection with the AP MAC privacy component 130-c, various aspects related to protecting the privacy of source and destination addresses.

The AP 105-c may further include an AP security component 1090. The AP security component 1090 may perform a security association with at least one other wireless station 115 or AP 105.

The transceiver 1030 may include a modem configured to modulate the packets and provide the modulated packets to the antennas 1040 for transmission, and to demodulate packets received from the antennas 1040. The transceiver 1030 may be implemented as at least one transmitter and at least one separate receiver. The transceiver 1030 may be configured to communicate bi-directionally, via the antennas 1040, with at least one wireless station 115 as illustrated in FIGS. 1-3, for example. The AP 105-c may typically include multiple antennas 1040 (e.g., an antenna array). The AP 105-c may communicate with a core network 1080 through the network communications component 1070. The AP 105-c may communicate with other APs, such as the access point 105-d and the access point 105-e, using an APs communications component 1060.

According to the architecture of FIG. 10, the AP 105-c may further include a communications management component 1050. The communications management component 1050 may manage communications with stations and/or other devices as illustrated in the WLAN network 100 of FIG. 1. The communications management component 1050 may be in communication with some or all of the other components of the AP 105-c via the bus or buses 1005. Alternatively, functionality of the communications management component 1050 may be implemented as a component of the transceiver 1030, as a computer program product, and/or as at least one controller element of the processor 1010.

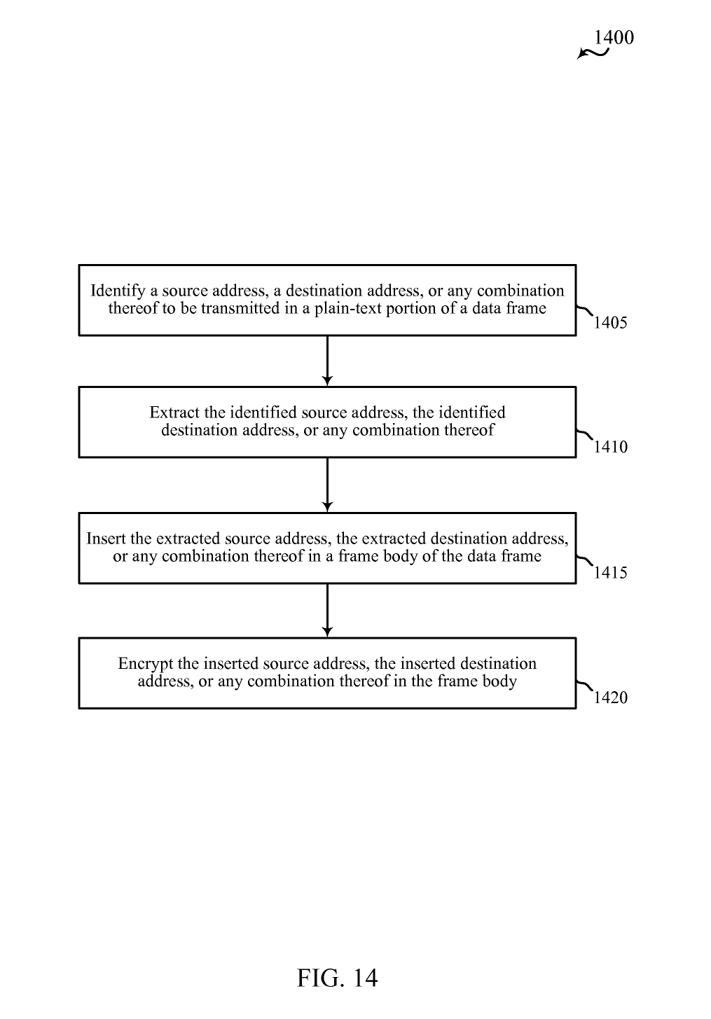

The components of the AP 105-c may be configured to implement aspects discussed above with respect FIGS. 1-9, and those aspects may not be repeated here for the sake of brevity. Moreover, the components of the AP 105-c may be configured to implement aspects discussed below with respect to FIGS. 14-17 and those aspects may not be repeated here also for the sake of brevity.

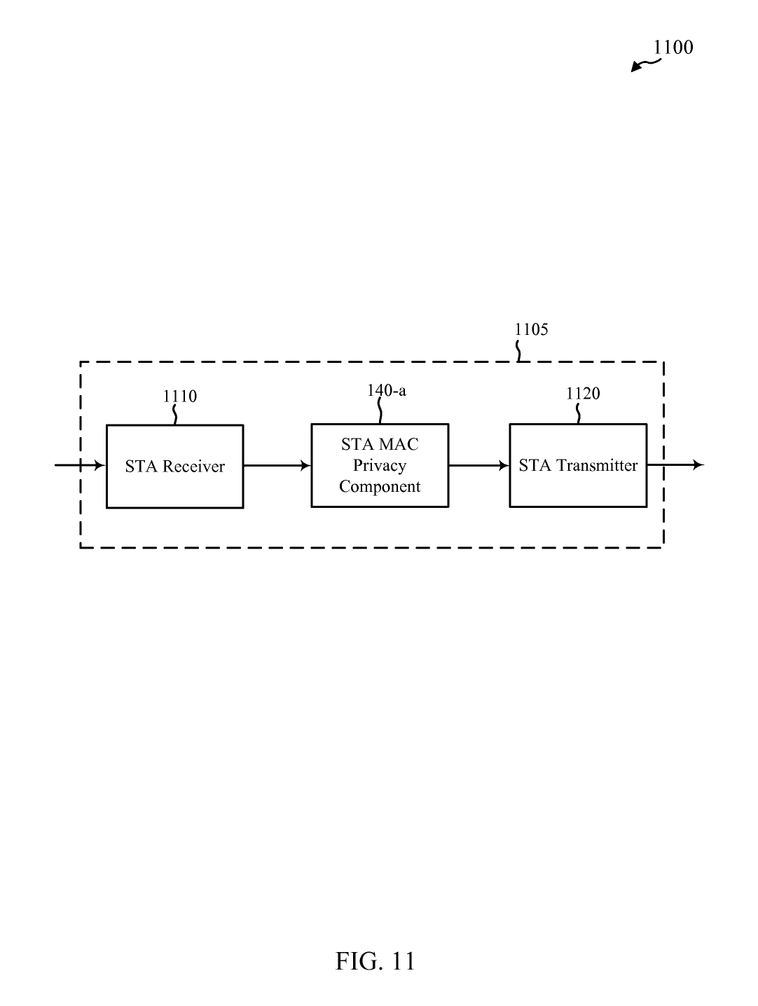

FIG. 11 shows a block diagram 1100 of an apparatus 1105 for use in a station for wireless communication, in accordance with various aspects of the present disclosure. In some examples, the apparatus 1105 may be an example of aspects of at least one of the wireless stations 115 described with reference to FIGS. 1-3. The apparatus 1105 may also be or include a processor. The apparatus 1105 may include a STA receiver 1110, a STA MAC privacy component 140-a, and a STA transmitter 1120. Each of these modules may be in communication with each other.

The apparatus 1105, through the STA receiver 1110, the STA MAC privacy component 140-a, and/or the STA transmitter 1120, may be configured to perform functions described herein. For example, the apparatus 1105 may be configured to may be configured to manage aspects of securing an address 3 field or an address 4 field in a frame body of a data frame.

The components of the apparatus 1105 may, individually or collectively, be implemented using at least one ASIC adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by at least one general or application-specific processor.

The STA receiver 1110 may receive information such as packets, user data, and/or control information associated with various information channels (e.g., control channels, data channels, etc.). The STA receiver 1110 may be configured to receive data frames where an address 3 or an address 4 is encrypted in a frame body. The STA receiver 1110 may also be configured to receive signals for a security association or a syntax element indicating that the address 3 or the address 4 is encrypted in a frame body. Information may be passed on to the STA MAC privacy component 140-a, and to other components of the apparatus 1105.

The STA MAC privacy component 140-a may be an example of at least one aspect of the STA MAC privacy component 140 described with reference to FIG. 1. The STA MAC privacy component 140-a may function differently depending on whether the apparatus 1105 is transmitting or receiving a data frame according to techniques described herein.

When the apparatus 1105 is receiving a data frame, the STA MAC privacy component 140-a may perform a security association with the transmitter of the data frame. The security association may inform the STA MAC privacy component 140-a that at least an address 3 is encrypted in a frame body of a data frame to be transmitted by the transmitter. In other examples, the STA MAC privacy component 140-a determines the presence of the addresses in the frame body based on the ToDS and FromDS values in the frame control field. In some examples, the security association also informs the AP MAC privacy component 140-a of where in the frame body the addresses are stored. The STA receiver 1110 may receive the data frame and provide it to the STA MAC privacy component 140-a. The STA MAC privacy component 140-a may decrypt the frame body.

Once decrypted, the STA MAC privacy component 140-a may determine the address 3 or the address 4 from the decrypted frame body. In one example, the STA MAC privacy component 140-a cuts a first portion of the frame body (e.g., the first six octets) and pastes it into an address 3 field of the frame header. If the address 4 is present, the STA MAC privacy component 140-a cuts a second portion of the frame body (e.g., the next six octets) and pastes it into an address 4 field of the frame header. Thus, the STA MAC privacy component 140-a recreates the typical MAC frame header format. In some examples, the first portion is the first six octets of the frame body and the second portion is the second six octets of the frame body. In another example, the second portion is the last six octets of the frame body and the first portion is the next-to-last six octets of the frame body. In another example, if EUI-64 is used for the MAC addresses, the STA MAC privacy component 140-a takes eight octets for the address 3 and address 4 fields.

When the apparatus 1105 is transmitting a data frame, the STA MAC privacy component 140-a may perform a security association with the receiver. The security association may inform the receiver that at least an address 3 is encrypted in a frame body of a data frame to be received by the receiver. In some examples, the STA MAC privacy component 140-a also uses the security association to inform the receiver of where in the frame body the addresses are stored.

Before encrypting the frame body, the STA MAC privacy component 140-a may copy the address 3 and the address 4 (if present) from the frame header and prepend them to the frame body. In one example, the STA MAC privacy component 140-a prepends the addresses in the same order. In some examples, the STA MAC privacy component 140-a may prepend the addresses in a reverse order, as long as the receiver can determine the order. The STA MAC privacy component 140-a may add the address 3 and address 4 to the beginning or the end of the frame body.

The STA MAC privacy component 140-a may set the address 3 field and, if present, the address 4 field in the plain-text portion of the data frame (e.g., MAC header) to a fixed value. In one example, the fixed value is all zeros. In another example, the STA MAC privacy component 140-a deletes the address 3 field and the address 4 field from the plain-text portion of the data frame. Next, the STA MAC privacy component 140-a may encrypt the frame body, including the added address 3 and, if present, address 4. That is, the STA MAC privacy component 140-a starts or ends the encryption of the frame body from the prepended address 3 or the prepended addresses 3 and 4. The STA MAC privacy component 140-a may provide the encrypted data frame to the AP transmitter 820.

The STA transmitter 1120 may transmit the at least one signal received from other components of the apparatus 1105. The STA transmitter 1120 may transmit the encrypted data frame according to the address 1 field of the plain-text portion. In some examples, the STA transmitter 1120 may be collocated with the receiver 1110 in a transceiver module. The STA transmitter 1120 may include a single antenna, or it may include a plurality of antennas.

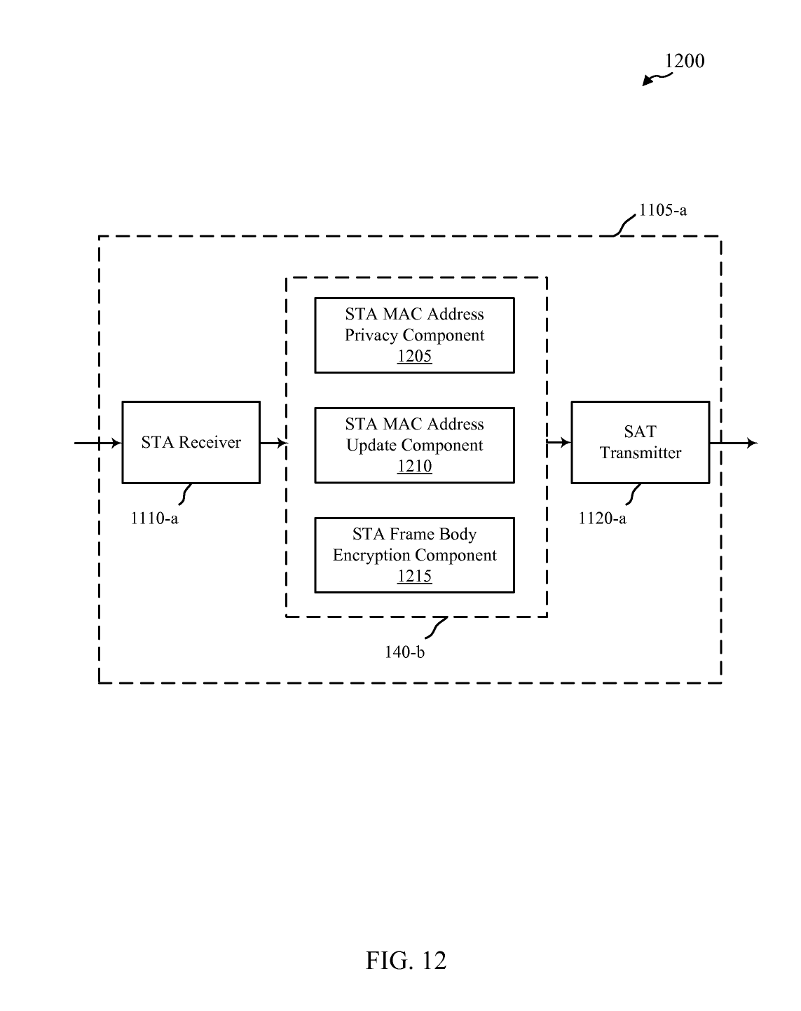

FIG. 12 shows a block diagram 1200 of an apparatus 1105-a that is used in a wireless station for wireless communication, in accordance with various examples. The apparatus 1105-a may be an example of at least one aspect of a wireless station 115 described with reference to FIGS. 1-3. It may also be an example of an apparatus 1105 described with reference to FIG. 11. The apparatus 1105-a may include a STA receiver 1110-a, a STA MAC privacy component 1115-a, and a STA transmitter 1120-a, which may be examples of the corresponding modules of apparatus 1105. The apparatus 1105-a may also include a processor. Each of these modules may be in communication with each other. The STA MAC privacy component 1115-a may include a STA MAC address privacy component 1205, a STA MAC address update component 1210, and a STA frame body encryption component 1215. The STA receiver 1110-a and the STA transmitter 1120-a may perform the functions of the receiver 1110 and the transmitter 1120, of FIG. 11, respectively.

The STA MAC address privacy component 1205 may protect the privacy of a source and destination address of a data frame by hiding them in a frame body of the data frame. The STA MAC address privacy component 1205 may identify an address 3 and an address 4 in a MAC header or in a decrypted frame body. The STA MAC address privacy component 1205 may copy the address 3 and, if present, the address 4 from the MAC address and insert them into the frame body according to examples described herein. The STA MAC address privacy component 1205 may also perform security associations with the receiver of the data frame. The STA MAC address privacy component 1205 may inform the receiver that the address 3 and 4 fields are hidden in the frame body.

The STA MAC address update component 1210 may protect the privacy of a source and destination address of a data frame by removing them from a plain-text portion of the data frame. Once the address values are located in the frame body, the STA MAC address update component 1210 may modify the address 3 and address 4 fields in the MAC header. The STA MAC address update component 1210 may replace the addresses with fixed values or remove the address fields from the plain-text portion of the data frame.

The STA MAC address update component 1210 may also replace the source and destination addresses of a data frame by removing them from the frame body and pasting them in the appropriate address fields of the plain-text portion of the data frame. The STA MAC address update component 1210 may determine where the address 3 and the address 4 are located in the frame body. The STA MAC address update component 1210 may reconstruct the MAC header by locating the addresses, cutting the values, and replacing them in the address fields.

The STA frame body encryption component 1215 may encrypt the frame body to prepare the data frame for transmission. The STA frame body encryption component 1215 may encrypt the address 3 and address 4 portions of the frame body. The STA frame body encryption component 1215 may also decrypt frame bodies of received data frames.

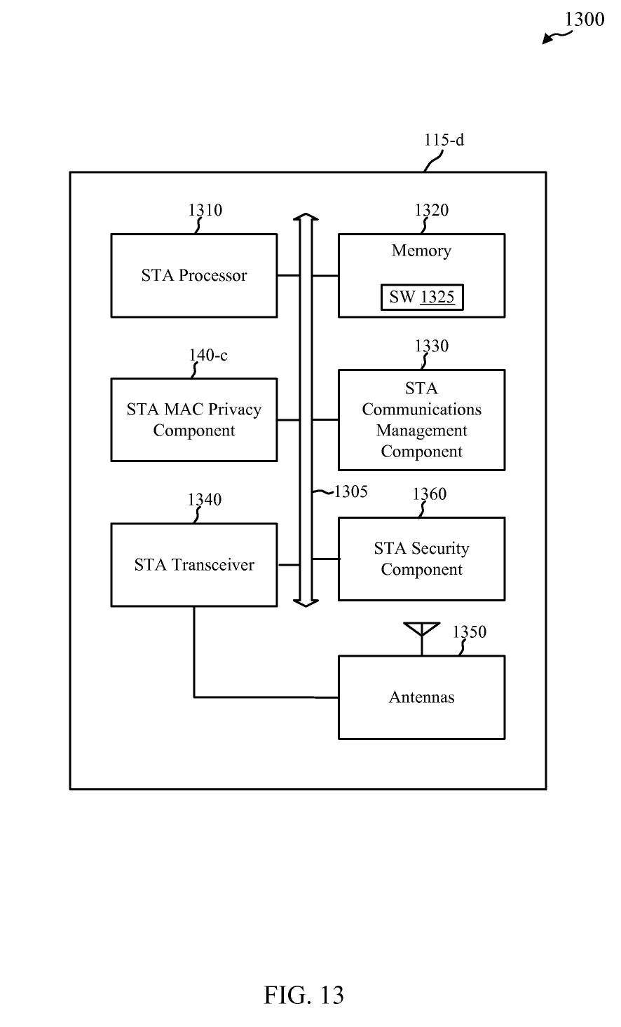

Turning to FIG. 13, a block diagram 1300 is shown that illustrates a wireless station 115-d configured for MAC address privacy. The wireless station 115-d may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The wireless station 115-d may have an internal power supply, such as a small battery, to facilitate mobile operation. The wireless station 115-d may be an example of the wireless stations 115 of FIGS. 1-3.

The wireless station 115-d may include a STA processor 1310, a memory 1320, a STA transceiver 1340, antennas 1350, and a STA MAC privacy component 140-c. The STA MAC privacy component 140-c may be an example of the STA MAC privacy component 140 of FIGS. 1 and 11-12. Each of these components may be in communication with each other, directly or indirectly, over at least one bus 1305.

The memory 1320 may include RAM and ROM. The memory 1320 may store computer-readable, computer-executable software (SW) code 1325 containing instructions that are configured to, when executed, cause the STA processor 1310 to perform various functions described herein for generating or removing source and destination addresses from frame bodies, for example. Alternatively, the software code 1325 may not be directly executable by the STA processor 1310 but be configured to cause the computer (e.g., when compiled and executed) to perform functions described herein.

The STA processor 1310 may include an intelligent hardware device, e.g., a CPU, a microcontroller, an ASIC, or the like. The STA processor 1310 may process information received through the STA transceiver 1340 and/or to be sent to the STA transceiver 1340 for transmission through the antennas 1350. The STA processor 1310 may handle, alone or in connection with the STA MAC privacy component 140-c, various aspects related to protecting the privacy of source and destination addresses.

The STA transceiver 1340 may be configured to communicate bi-directionally with APs 105 in FIGS. 1-3 and 10. The STA transceiver 1340 may be implemented as at least one transmitter and at least one separate receiver. The STA transceiver 1340 may include a modem configured to modulate the packets and provide the modulated packets to the antennas 1350 for transmission, and to demodulate packets received from the antennas 1350. While the wireless station 115-d may include a single antenna, there may be aspects in which the wireless station 115-d may include multiple antennas 1350.

According to the architecture of FIG. 13, the wireless station 115-d may further include a STA communications management component 1330. The STA communications management component 1330 may manage communications with various access points. The STA communications management component 1330 may be a component of the wireless station 115-d in communication with some or all of the other components of the wireless station 115-d over the at least one bus 1305. Alternatively, functionality of the STA communications management component 1330 may be implemented as a component of the STA transceiver 1340, as a computer program product, and/or as at least one controller element of the STA processor 1310.

The wireless station 115-d may further include a STA security component 1360. The STA security component 1360 may perform a security association with at least one other wireless station 115 or AP 105.

The components of the wireless station 115-d may be configured to implement aspects discussed above with respect to FIGS. 1-7 and 11-12, and those aspects may not be repeated here for the sake of brevity. Moreover, the components of the wireless station 115-d may be configured to implement aspects discussed below with respect to FIGS. 14-17, and those aspects may not be repeated here also for the sake of brevity.

FIG. 14 is a flow chart illustrating an example of a method 1400 for wireless communication, in accordance with various aspects of the present disclosure. For clarity, the method 1400 is described below with reference to aspects of at least one of the APs 105 or wireless stations 115 described with reference to FIGS. 1-3, 10, and 13 or aspects of at least one of the devices 805 or apparatuses 1105 described with reference to FIGS. 8-9 and 11-12. In some examples, an AP 105 or wireless station 115 may execute at least one set of codes to control the functional elements of the AP 105 or wireless station 115 to perform the functions described below. Additionally or alternatively, the AP 105 or wireless station 115 may perform at least one of the functions described below using special-purpose hardware.

At block 1405, the method 1400 may include identifying a source address, a destination address, or any combination thereof to be transmitted in a plain-text portion of a data frame. For example, an AP 105 or wireless station 115 may determine that a plain-text portion of a data frame includes an address 3 and an address 4.

The method 1400 also includes, at block 1410, extracting the identified source address, the identified destination address, or any combination thereof. In some cases, the identified source address, the identified destination address, or any combination thereof may be extracted from the plain-text portion of the data frame. For example, the AP 105 or the wireless station 115 may copy the address 3 and the address 4 from the plain-text portion. In some examples of the method 1400, the method 1400 includes modifying at least one address field of the plain-text portion of the data frame. In some examples, modifying the address field further includes setting the at least one address field to a fixed value. For example, the AP 105 may copy an address from the address 3 field and then change the address 3 field to a fixed value, such as all zeros. In some examples, modifying the address field further includes removing the source address, the destination address, or any combination thereof from the plain-text portion of the data frame.

At block 1415, the method 1400 may also include inserting the extracted source address, the extracted destination address, or any combination thereof in a frame body of the data frame. In some examples, inserting the extracted source address or the extracted destination address further includes appending at least one of the source address or the destination address to a beginning of the frame body. In some examples, appending the source address, the destination address, or any combination thereof to the beginning of the frame body further includes appending the destination address to the beginning of the source address. In other examples, inserting the source address, the destination address, or any combination thereof further includes appending at least one of the source address or the destination address to an end of the frame body. For example, the wireless station 115 may append the destination address and the source address to the end or the beginning of the frame body, in that order.

At block 1420, the method 1400 may further include encrypting the inserted source address, the inserted destination address, or any combination thereof in the frame body. In some examples, the method 1400 further includes indicating the encryption of the source address, the destination address, or any combination thereof in a security association with a receiver of the data frame. In some examples, the security association is a 4-way handshake procedure.

In some examples of the method 1400, the plain-text portion of the data frame is a MAC header. In additional examples, the method 1400 includes signaling a syntax element to a receiver that indicates a presence of at least the source address or the destination address in the frame body.

The method 1400 may also include transmitting the data frame according to an address that is different from the source address and the destination address. For example, the AP 105 may transmit the data frame to an intermediary address that is not the destination address.

In a further example, the method 1400 includes receiving the data frame and identifying the at least one of the source address or the destination address from an encrypted frame body of the data frame. The method 1400 may further include identifying an intermediary address based at least in part on the destination address and transmitting the data frame according to the intermediary address.

The operations at blocks 1405, 1410, 1415, and 1420 may be performed using the AP MAC privacy component 130 or the STA MAC privacy component 140 described with reference to FIGS. 1 and 8-13. Thus, the method 1400 may provide for wireless communication. It should be noted that the method 1400 is just one implementation and that the operations of the method 1400 may be rearranged or otherwise modified such that other implementations are possible.

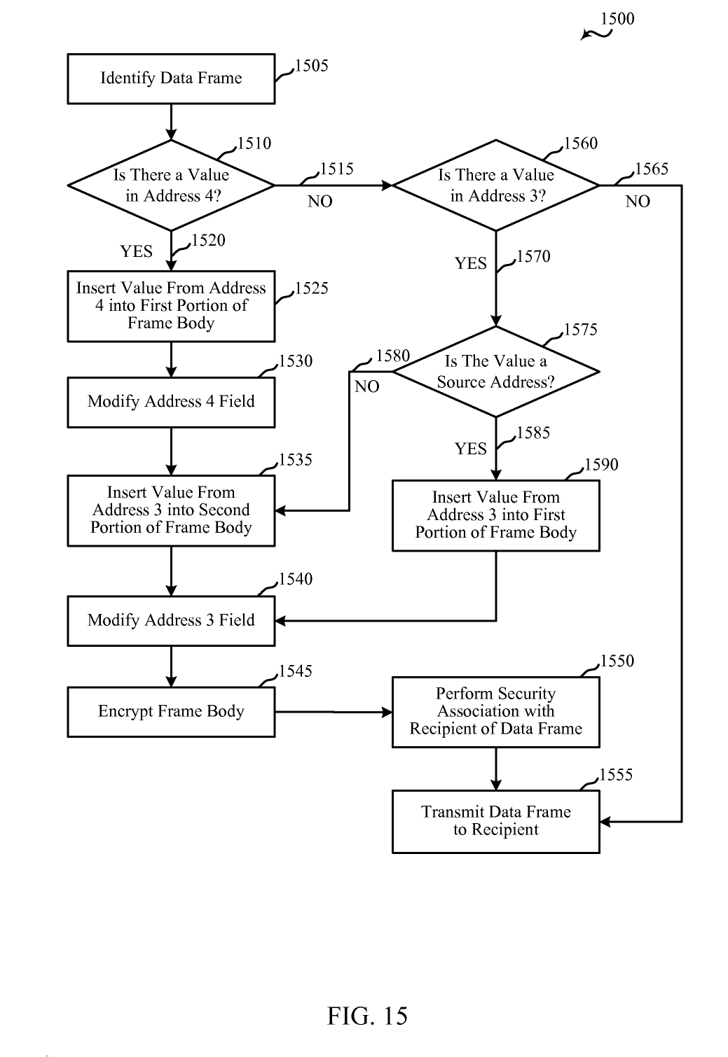

FIG. 15 is a flow chart illustrating an example of a method 1500 for wireless communication, in accordance with various aspects of the present disclosure. For clarity, the method 1500 is described below with reference to aspects of at least one of the APs 105 or wireless stations 115 described with reference to FIGS. 1-3, 10, and 13 or aspects of at least one of the devices 805 or apparatuses 1105 described with reference to FIGS. 8-9 and 11-12. In some examples, an AP 105 or wireless station 115 may execute at least one set of codes to control the functional elements of the AP 105 or wireless station 115 to perform the functions described below. Additionally or alternatively, the AP 105 or wireless station 115 may perform at least one of the functions described below using special-purpose hardware.

The method 1500 is applicable to an AP 105 or a wireless station 115 transmitting a data frame according to the privacy techniques described herein. For simplicity, the method 1500 is described with respect to an AP 105 performing the method 1500. However, a wireless station 115 may also perform the method 1500.

At block 1505, the AP 105 determines a data frame. Determining a data frame may be either by generating the data frame or receiving the data frame. At block 1510, the AP 105 determines whether there is a value in an address 4 field. That is, the method 1500 includes determining whether an address 4 field is used. In one example, the AP 105 determines the address 4 field exists by noting that the ToDS and the FromDS fields are set to 1. In another example, the AP 105 may have been informed by transmitter of the data frame that an address 4 field is used. If the AP 105 has received the data frame, then the AP 105 may have already decrypted the frame body and determined an address 4 field is included.

If the AP 105 determines that the address 4 field is included, the method 1500 follows path 1520 to block 1525. At block 1525, the AP 105 inserts the value from the address 4 field into a first portion of a frame body. In one example, the first portion may be a second set of bits from the beginning of the frame body, such as shown in the address 4 portion 435-a illustrated in FIG. 6. In another example, the first portion may be a last set of bits from the end of the frame body, such as shown in the address 4 portion 435-b illustrated in FIG. 7.

At block 1530, the method 1500 may further include modifying the address 4 field in the plain-text portion of the data frame. For example, the AP 105 may modify the value of the address 4 field in the plain-text portion to a value that does not identify the source address, such as a fixed value. In another example, the AP 105 may modify the value of the address 4 field in the plain-text portion by deleting the address 4 field from the plain-text portion.

At block 1535, the method 1500 may further include inserting the value from the address 3 field into a second portion of the frame body. In one example, the second portion may be a first set of bits from the beginning of the frame body, such as shown in the address 3 portion 425-a illustrated in FIG. 6. In another example, the second portion may be a second-to-last set of bits from the end of the frame body, such as shown in the address 3 portion 425-b illustrated in FIG. 7. For example, the second portion may be in front of and contiguous with the first portion.

At block 1540, the method 1500 may further include modifying the address 3 field in the plain-text portion of the data frame. For example, the AP 105 may modify the value of the address 3 field in the plain-text portion to a value that does not identify the address, such as a fixed value. In another example, the AP 105 may modify the value of the address 3 field in the plain-text portion by deleting the address 3 field from the plain-text portion.

At block 1545, the method 1500 includes encrypting the frame body. Encrypting the frame body includes encrypting the copied address 3 and address 4 portions of the frame body. At block 1550, the method 1500 includes performing a security association with the recipient of the data frame (e.g., identified in the address 1 field). At block 1555, the method 1500 includes transmitting the data frame to the recipient.

Returning to block 1510, if there is no address 4, the method 1500 proceeds along path 1515 to block 1560. At block 1560, the method determines if there is a value besides a BSSID in the address 3 field. If there is no address 3 field that identifies a source address or a destination address, the method 1500 proceeds to block 1555 and transmits the data frame to the recipient, as there are no addresses to hide in the frame body.

Returning to block 1560, if there is a value in the address 3 field, the method 1500 proceeds along path 1570 to block 1575. At block 1575, the method 1500 determines if the value is a source address. If the address 3 field does not identify a source address, the method 1500 proceeds along path 1580 to block 1590, and places the value from the address 3 field into a second portion of the frame body. For example, there is no first portion of the frame body used, so the second portion is continuous with either the beginning or the end of the frame body. The method 1500 then proceeds as described above.

Returning to block 1575, if the method 1500 determines the value is a source address, the method 1500 proceeds along path 1585 to block 1590. At block 1590, the method 1500 places the value from the address 3 field into a first portion of the frame body. In this example, the first portion of the frame body is continuous with either the beginning or the end of the frame body. The method 1500 then proceeds to modify the address 3 field at block 1540. The method 1500 then proceeds as described above.

The operations at blocks 1505 through 1590 may be performed using the AP MAC privacy component 130 or the STA MAC privacy component 140 described with reference to FIGS. 1 and 8-13. Thus, the method 1500 may provide for wireless communication. It should be noted that the method 1500 is just one implementation and that the operations of the method 1500 may be rearranged or otherwise modified such that other implementations are possible.

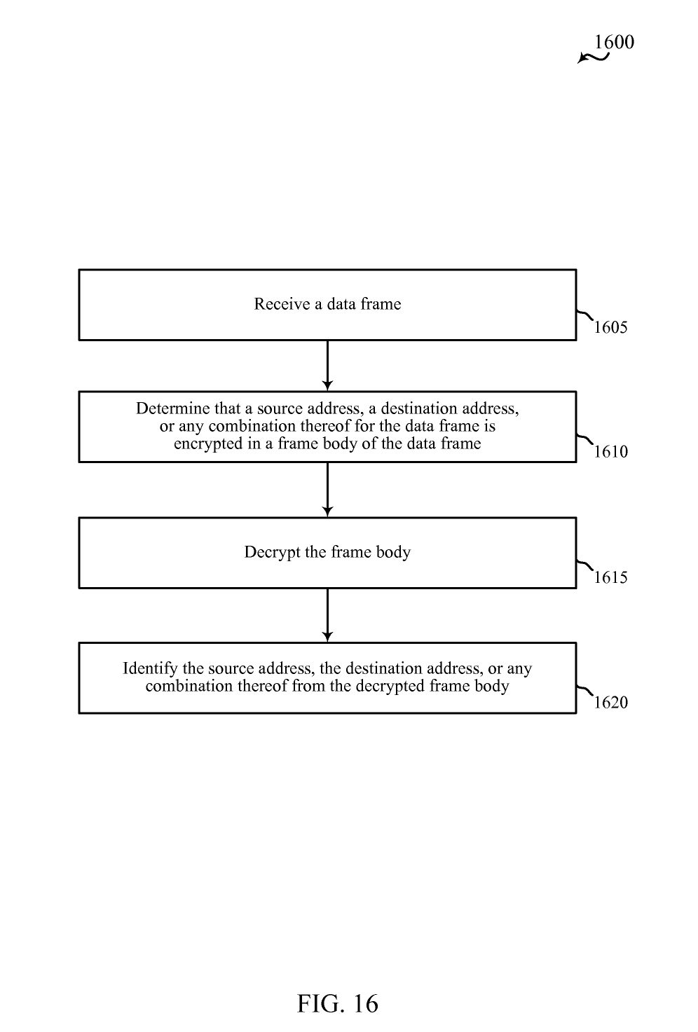

FIG. 16 is a flow chart illustrating an example of a method 1600 for wireless communication, in accordance with various aspects of the present disclosure. For clarity, the method 1600 is described below with reference to aspects of at least one of the APs 105 or wireless stations 115 described with reference to FIGS. 1-3, 10, and 13 or aspects of at least one of the devices 805 or apparatuses 1105 described with reference to FIGS. 8-9 and 11-12. In some examples, an AP 105 or wireless station 115 may execute at least one set of codes to control the functional elements of the AP 105 or wireless station 115 to perform the functions described below. Additionally or alternatively, the AP 105 or wireless station 115 may perform at least one of the functions described below using special-purpose hardware.

At block 1605, the method 1600 may include receiving a data frame. The AP 105 or wireless station 115 may receive a data frame with an encrypted frame body. At block 1610, the method 1600 further includes determining that a source address, a destination address, or any combination thereof for the data frame is encrypted in a frame body of the data frame. The AP 105 or wireless station 115 may determine at least one of the addresses is encrypted through the frame control of the plain-text portion, through signaling from the transmitter, or through a security association with the transmitter. The method 1600 may further include decrypting the frame body at block 1615.

At block 1620, the method 1600 further includes identifying the source address, the destination address, or any combination thereof from the decrypted frame body. In some examples, identifying the source address, the destination address, or any combination thereof further includes identifying at least one of the source address or the destination address from a first portion of the decrypted frame body. In another example, identifying the source address, the destination address, or any combination thereof further includes determining the source address from a first portion of the decrypted frame body and determining the destination address from a second portion of the decrypted frame body. In some examples, the second portion is a first set of bits starting at a beginning of the frame body and the first portion is a second set of bits starting at an end of the first set of bits.

In another example, the method 1600 further includes identifying a presence of the destination address from a frame control field of the data frame. In another example, the method 1600 further includes replacing an address field of a plain-text portion of the data frame with the source address.

In a further example, the method 1600 includes replacing an address field of a plain-text portion of the data frame with the destination address. In some examples, the plain-text portion of the data frame is a medium access control (MAC) header of the data frame. In some examples, wherein determining that the at least one of the source address or the destination address is encrypted further includes determining the at least one of the source address or destination address is encrypted from a security association with a transmitter of the data frame. In some examples, the security association includes a 4-way handshake procedure.

In another example of the method 1600, determining that the at least one of the source address or the destination address is encrypted further includes determining a presence of at least the source address or the destination address in the frame body from a syntax element associated with the data frame.

In yet another example, the method 1600 includes identifying an intermediary address based at least in part on the destination address, encapsulating the source address and the destination address in the frame body, encrypting the frame body, and transmitting the data frame according to the intermediary address.

The operations at blocks 1605, 1610, 1615, and 1620 may be performed using the AP MAC privacy component 130 or the STA MAC privacy component 140 described with reference to FIGS. 1 and 8-13. Thus, the method 1600 may provide for wireless communication. It should be noted that the method 1600 is just one implementation and that the operations of the method 1600 may be rearranged or otherwise modified such that other implementations are possible.

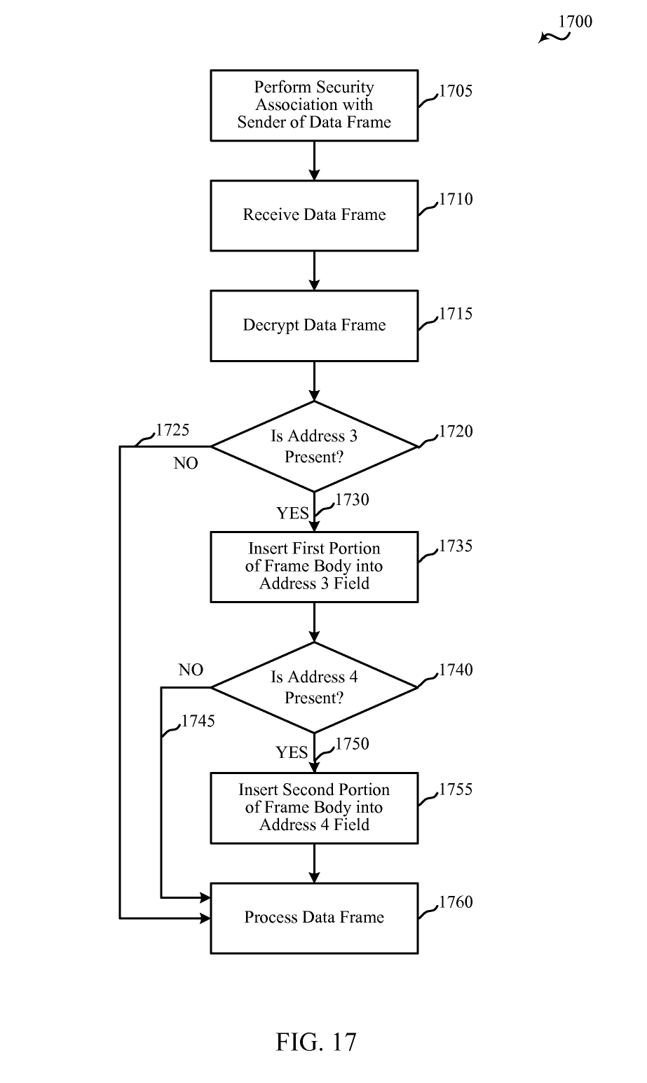

FIG. 17 is a flow chart illustrating an example of a method 1700 for wireless communication, in accordance with various aspects of the present disclosure. For clarity, the method 1700 is described below with reference to aspects of at least one of the APs 105 or wireless stations 115 described with reference to FIGS. 1-3, 10, and 13 or aspects of at least one of the devices 805 or apparatuses 1105 described with reference to FIGS. 8-9 and 11-12. In some examples, an AP 105 or wireless station 115 may execute at least one set of codes to control the functional elements of the AP 105 or wireless station 115 to perform the functions described below. Additionally or alternatively, the AP 105 or wireless station 115 may perform at least one of the functions described below using-purpose hardware.

The method 1700 is applicable to an AP 105 or a wireless station 115 transmitting a data frame according to the privacy techniques described herein. For simplicity, the method 1700 is described with respect to an AP 105 performing the method 1700. However, a wireless station 115 may also perform the method 1700.

At block 1705, the AP 105 performs a security association with a sender of a data frame. At block 1710, the AP 105 receives a data frame from the same device with which the AP 105 performed the security association. At block 1715, the method 1700 decrypts the data frame.

At block 1720, the method 1700 determines whether the address 3 is present. If the address 3 is not present, the method 1700 proceeds along path 1725 to block 1760. At block 1760, the method 1700 includes proceeding with the data frame as normal. In such a case, there are no encrypted addresses in the frame body. However, if the address 3 is present, the method 1700 proceeds along path 1730 to block 1735.

At block 1735, the method 1700 inserts a first portion of a frame body into the address 3 field. This portion may be the beginning portion at the beginning of the frame body or may be the end portion contiguous with the end of the frame body.

At block 1740, the method 1700 determines whether the address 4 is present. If the address 4 is not present, the method 1700 proceeds along path 1745 to block 1760. At block 1760, the method 1700 includes proceeding with the data frame. In this case, the data frame includes the address 3 field, which may be a source address or a destination address.

If the address 4 is present, the method 1700 proceeds along path 1750 to block 1755. At block 1755, the method 1700 inserts a second portion of the frame body into the address 4 field. This portion may be the portion next to the first portion at the beginning of the frame body or may be the end portion of the frame body. At block 1760, the method 1700 includes proceeding with the data frame. In this case, the data frame includes the address 3 and the address 4 fields, which may be a source address and a destination address.

The operations at blocks 1705 through 1760 may be performed using the AP MAC privacy component 130 or the STA MAC privacy component 140 described with reference to FIGS. 1 and 8-13. Thus, the method 1700 may provide for wireless communication. It should be noted that the method 1700 is just one implementation and that the operations of the method 1700 may be rearranged or otherwise modified such that other implementations are possible.

In some examples, aspects from two or more of the methods 1400-1700 may be combined. It should be noted that the methods 1400, 1500, 1600, and 1700 are just example implementations, and that the operations of the methods 1400-1700 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted over as at least one instruction or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
identifying a source address, a destination address, or any combination thereof to be transmitted in a plain-text portion of a data frame;
extracting the identified source address, the identified destination address, or any combination thereof;
inserting the extracted source address, the extracted destination address, or any combination thereof in a frame body of the data frame; and
encrypting the inserted source address, the inserted destination address, or any combination thereof in the frame body.

2. The method of claim 1, wherein the identified source address, the identified destination address, or any combination thereof is extracted from the plain-text portion of the data frame.

3. The method of claim 1, wherein extracting the identified source address, the identified destination address, or any combination thereof further comprises:
modifying at least one address field of the plain-text portion of the data frame.

4. The method of claim 2, wherein modifying the at least one address field further comprises:
setting the at least one address field to a fixed value.

5. The method of claim 2, wherein modifying the at least one address field further comprises:
removing the source address, the destination address, or any combination thereof from the plain-text portion of the data frame.

6. The method of claim 1, wherein the plain-text portion of the data frame comprises a medium access control (MAC) header.

7. The method of claim 1, wherein inserting the extracted source address, the extracted destination address, or any combination thereof further comprises:
appending the source address, the destination address, or any combination thereof to a beginning of the frame body.

8. The method of claim 6, wherein appending the source address, the destination address, or any combination thereof to the beginning of the frame body further comprises:
appending the destination address to the beginning of the source address.

9. The method of claim 1, wherein inserting the extracted source address, the extracted destination address, or any combination thereof further comprises:
appending the source address, the destination address, or any combination thereof to an end of the frame body.

10. The method of claim 1, further comprising:
indicating the encryption of the source address, the destination address, or any combination thereof in a security association with a receiver of the data frame.

11. The method of claim 9, wherein the security association comprises a 4-way handshake procedure.

12. The method of claim 1, further comprising:
signaling a syntax element to a receiver that indicates a presence of the source address, the destination address, or any combination thereof in the frame body.

13. The method of claim 1, further comprising:
transmitting the data frame according to an address that is different from the source address and the destination address.

14. The method of claim 1, further comprising:
receiving the data frame;
identifying the source address, the destination address, or any combination thereof from an encrypted frame body of the data frame;
identifying an intermediary address based at least in part on the destination address; and
transmitting the data frame according to the intermediary address.

15. An apparatus for wireless communication, comprising:
a medium access control (MAC) address privacy component to identify a source address, a destination address, or any combination thereof to be transmitted in a plain-text portion of a data frame and to extract the identified source address, the identified destination address, or any combination thereof;
a MAC address update component to insert the extracted source address, the extracted destination address, or any combination thereof in a frame body of the data frame; and
a frame body encryption component to encrypt the inserted source address, the inserted destination address, or any combination thereof in the frame body.

16. The apparatus of claim 14, wherein the MAC address privacy component is further to:
modify at least one address field of the plain-text portion of the data frame.

17. A method for wireless communication, comprising:
receiving a data frame;
determining that a source address, a destination address, or any combination thereof for the data frame is encrypted in a frame body of the data frame;
decrypting the frame body; and
identifying the source address, the destination address, or any combination thereof from the decrypted frame body.

18. The method of claim 16, wherein identifying the source address, the destination address, or any combination thereof further comprises:
identifying the source address, the destination address, or any combination thereof from a first portion of the decrypted frame body.

19. The method of claim 17, wherein identifying the source address, the destination address, or any combination thereof further comprises:
determining the source address from a first portion of the decrypted frame body; and
determining the destination address from a second portion of the decrypted frame body.

20. The method of claim 18, wherein the second portion comprises a first set of bits starting at a beginning of the frame body and the first portion comprises a second set of bits starting at an end of the first set of bits.

21. The method of claim 16, further comprising:
identifying a presence of the source address, the destination address, or any combination thereof from a frame control field of the data frame.

22. The method of claim 16, further comprising:
replacing an address field of a plain-text portion of the data frame with the source address.

23. The method of claim 16, further comprising:
replacing an address field of a plain-text portion of the data frame with the destination address.

24. The method of claim 22, wherein the plain-text portion of the data frame comprises a medium access control (MAC) header of the data frame.

25. The method of claim 16, wherein determining that the source address, the destination address, or any combination thereof is encrypted further comprises:
determining the source address, the destination address, or any combination thereof is encrypted from a security association with a transmitter of the data frame.

26. The method of claim 16, wherein determining that the source address, the destination address, or any combination thereof is encrypted further comprises:
determining a presence of the source address, the destination address, or any combination thereof in the frame body from a syntax element associated with the data frame.

27. The method of claim 16, further comprising:
identifying an intermediary address based at least in part on the destination address;
encapsulating the source address and the destination address in the frame body;
encrypting the frame body; and
transmitting the data frame according to the intermediary address.

28. The method of claim 16, further comprising:
inserting the extracted source address, the extracted destination address, or any combination thereof in a frame header of the data frame.

29. An apparatus for wireless communication, comprising:
a receiver to receive a data frame;
a medium access control (MAC) address privacy component to determine that a source address, a destination address, or any combination thereof for the data frame is encrypted in a frame body of the data frame;
a frame body encryption component to decrypt the frame body; and
a MAC address update component to identify the source address, the destination address, or any combination thereof from the decrypted frame body.

30. The apparatus of claim 29, wherein the MAC address update component is further to:
identify the source address, the destination address, or any combination thereof from a first portion of the decrypted frame body.
